(19) United States
(12) Patent Application Publication
(10) Pub. No.: US 2026/0042451 A1
(43) Pub. Date: Feb. 12, 2026

(54) SYSTEM, METHOD, AND APPARATUS FOR PERFORMING VEHICLE DIAGNOSTIC AND CONFIGURATION OPERATIONS

(71) Applicant: Sonatus, Inc., Sunnyvale, CA (US)

(72) Inventors: Yu Fang, Palo Alto, CA (US); Yixiang Chen, Palo Alto, CA (US); Andrew Ling, Daly City, CA (US); Giridhar Akila Dhakshinamoorthy, Sunnyvale, CA (US)

(21) Appl. No.: 19/364,827

(22) Filed: Oct. 21, 2025

Related U.S. Application Data
(63) Continuation of application No. PCT/US2024/031110, filed on May 24, 2024.
(60) Provisional application No. 63/468,754, filed on May 24, 2023.

(51) Int. Cl. B60W 50/04; B60W 50/00

(52) U.S. Cl. CPC B60W 50/045; B60W 2050/0014; B60W 2050/041

(57) ABSTRACT

A system for performing an MTDM workflow. The system includes a vehicle data platform and a vehicle automation platform. The vehicle data platform is configured to provide a policy to a vehicle, where the policy includes an MTDM workflow element. The vehicle automation platform is configured to provide a recipe to the vehicle, where the recipe includes actions for an automated vehicle response. The vehicle data platform is further configured to receive collected data from the vehicle in response to an execution of at least one of the MTDM workflow element or the automated vehicle response by a controller of the vehicle.

### CROSS REFERENCE TO RELATED APPLICATIONS

The present application claims priority to and is a bypass continuation of International Patent Application No. PCT/US2024/031110, filed on May 24, 2024, and entitled “SYSTEM, METHOD, AND APPARATUS FOR PERFORMING VEHICLE DIAGNOSTIC AND CONFIGURATION OPERATIONS”, published as WO 2024/243560 (SONA-0017-WO).

International Patent Application No. PCT/US2024/031110 claims priority to U.S. Provisional Patent Application No. 63/468,754, filed on 24 May 2023, entitled “SYSTEM, METHOD AND APPARATUS FOR PERFORMING VEHICLE DIAGNOSTIC AND CONFIGURATION OPERATIONS” (SONA-0017-P01).

All of the foregoing applications and/or patents are incorporated herein by reference in their entirety for all purposes.

### BACKGROUND

Vehicles and mobile applications are increasingly reliant on computing devices distributed around the vehicle to perform electronic control functions. The proliferation of features, capabilities, and control operations on the vehicle drives challenges to ensuring that all computing devices, sensors, and actuators are operating properly and are updated, and drives complexity in determining the source of issues that may arise. Further, the specific configuration of each vehicle is complex, as vehicle can have distinct configurations of end points, network addresses, component models, and the like, both between vehicles having minor differences such as two vehicles in distinct model years, and even within a more closely related group of vehicles, for example due to upfits or updates, changes to components during production (e.g., due to lack of availability of identical parts, continuous improvement to manufacturing processes, response to issues found in vehicles in use, etc.). Further, customers and commercial considerations continuously raise expectations for proper vehicle operation, downtime performance, and increased feature capability, resulting in a situation where meeting expectations is more complex even as performance is expected to improve.

### SUMMARY

Embodiments herein provide for a number of improvements over previously known systems.

Example embodiments provide for convenient and high capability implementation to provide monitoring for issues on the vehicle, such as faults or failures, and/or sub-optimal operation that degrades performance without rising to an actual fault or failure. Embodiments herein additionally allow responsible users (e.g., manufacturers, OEMs, service personnel, body builders, aftermarket providers, fleet owners, and/or owners or operators in certain instances) to implement operations to monitor vehicles, perform testing operations, perform sophisticated diagnostics, and/or perform maintenance operations (collectively, MTDM operations), with both a high capability to reach any aspect of the vehicle that is within the scope of authority or permissions for each user, and with a convenient implementation, for example typically by providing one, or a few, files of data, and without requiring updates to software and the associated in-depth testing, certification, downtime, or other issues that come with an update to the software of the vehicle. Additionally, embodiments herein provide for a convenient interface to perform these operations, without requiring detailed knowledge by the user in relation to programming capability, or the specific configuration of individual vehicles. Additionally, embodiments herein provide for convenient rollout of MTDM operations to a group of vehicles, supporting broad upfits, improvements, recalls, or other similar operations, that can be rolled out intelligently to a group of vehicles with just a few inputs from the user. Further, embodiments herein provide for MTDM creation, implementation, and rollout to benefit from learning between different vehicles, allowing for early determination of issues with a particular MTDM operation before significant rework costs are incurred, and to more rapidly implement continuous improvement and converge on best practice configurations, improving the overall value of the MTDM system for the entire relevant group of vehicles.

The example benefits are non-limiting, and a given embodiment may lack one or more, or all, of the described benefits, and/or may include additional benefits that are not set forth in this summary.

### BRIEF DESCRIPTION OF THE FIGURES

The disclosure and the following detailed description of certain embodiments thereof may be understood by reference to the following figures:

FIG. 1 depicts an example MTDM system;

FIG. 2 depicts another example MTDM system;

FIG. 3 is a schematic depiction of a vehicle controller of an MTDM system;

FIG. 4 is a schematic depiction of a cloud controller of an MTDM system;

FIG. 5 is a schematic depiction of an MTDM workflow;

FIG. 6 is a schematic depiction of an example MTDM implementation;

FIG. 7 is a schematic depiction of an example MTDM implementation;

FIG. 8 is a schematic depiction of example operations of an automated escalation protocol;

FIG. 9 is a schematic depiction of an automated MTDM builder;

FIG. 10 is a schematic depiction of example recipe elements;

FIG. 11 is a schematic depiction of a procedure for implementing an automated escalation protocol;

FIG. 12 is a schematic depiction of a procedure to implement an MTDM interface;

FIG. 13 is a schematic depiction of a procedure to implement an MTDM interface;

FIG. 14 is a schematic depiction of a procedure to implement an MTDM interface;

FIG. 15 is a schematic depiction of a procedure to implement an MTDM interface;

FIG. 16 is a schematic depiction of a rollout operation;

FIG. 17 is a schematic depiction of a rollout operation;

FIG. 18 is a schematic depiction of a rollout operation;

FIG. 19 is a schematic depiction of a rollout operation;

FIG. 20 is a schematic depiction of a rollout operation;

FIG. 21 is a schematic depiction of a rollout operation; and

FIG. 22 is a schematic depiction of a rollout operation.

### DETAILED DESCRIPTION

Without limitation to any aspect of the present disclosure, some tools that can be utilized to tactically implement certain operations herein, in combination with the present disclosure, and descriptions that can enhance understanding of some of the terminology used herein (e.g., policy, end point, external device, network protocol, network type, etc.) can be found in one or more of the following U.S. patents or patent applications: U.S. application Ser. No. 17/027,167, filed 21 Sep. 2020, and entitled SYSTEM, METHOD, AND APPARATUS TO SUPPORT MIXED NETWORK COMMUNICATIONS ON A VEHICLE (SONA-0006-U01), issued as U.S. Pat. No. 11,411,823; U.S. application Ser. No. 17/027,187, filed 21 Sep. 2020, and entitled SYSTEM, METHOD, AND APPARATUS TO EXTRA VEHICLE COMMUNICATIONS CONTROL (SONA-0007-U01), issued as U.S. Pat. No. 11,228,496; U.S. application Ser. No. 17/195,589, filed 8 Mar. 2021, and entitled SYSTEM, METHOD, AND APPARATUS FOR MANAGING VEHICLE DATA COLLECTION (SONA-0010-U01), issued as U.S. Pat. No. 11,538,287; and U.S. application Ser. No. 17/833,614, filed 6 Jun. 2022, and entitled SYSTEM, METHOD, AND APPARATUS FOR MANAGING VEHICLE DATA COLLECTION (SONA-0012-U01), published as U.S. 2002-0297635 A1; each of which is incorporated herein by reference in the entirety for all purposes.

Without limitation to any other aspect of the present disclosure, monitoring operations as utilized herein should be understood broadly. Monitoring operations include operations to determine data values and/or system states from a vehicle, including determining the occurrence of specific events on the vehicle, such as certain operating conditions, and/or transitions between operating conditions. The monitoring may be related to any value, state, condition, or transition that is observable from the vehicle, including such aspects that are only intermittently observable (e.g., the data that is monitored is available under certain operating conditions that are not always present, or that theoretically may not always be present), and/or theoretically observable (e.g., the data that is monitored could be available under certain operating conditions, which may not be experienced by the vehicle during the monitoring period but could be if the relevant operating conditions were to occur). Monitoring operations may be an initiator for MTDM operations (e.g., monitor to detect a particular event, which is utilized to initiate further MTDM operations), a final MTDM operation for a particular sequence (e.g., after diagnostics, testing, and/or maintenance, certain monitoring operations continue for a selected period, and/or on an ongoing basis), and/or may be utilized during any portion of the MTDM operations (e.g., a test that utilizes monitoring operations during the test, between stages of the test, etc.).

Without limitation to any other aspect of the present disclosure, testing operations as utilized herein should be understood broadly. Testing operations include operations to determine whether a particular event, value, or state exists on the vehicle, generally for such aspects that are not readily apparent but become evident based on other conditions of the vehicle. For example, exceedance of a temperature where a temperature sensor that directly detects the temperature may not be a test operation, as the value is readily apparent by looking at one or two parameters on the vehicle. In another example, determining the transient response of a component of the vehicle during a particular operation may well be a testing operation, as the transient response will not typically have a single responsive data value available, and determination of the transient response and how it relates to expected or compliant values typically involves observation of a number of parameters, operation of models or correlations, comparisons to empirically determined values, or the like. In certain embodiments, testing may be passive (e.g., the test does not adjust any vehicle control parameters directly, but can be performed by observing data during normal vehicle operations without disturbing those operations), which may include requesting or retrieving data that is not ordinarily available (adding data parameters for observation does not typically disturb vehicle operations, although that could depend upon the amount of such data, the rate of data collection, and/or the amount of such data that is stored to support the test operations). In certain embodiments, testing may be active (e.g., the test adjusts parameters that override normal vehicle operations to some extent, and/or completely overrides the control of the vehicle, which may include ensuring the vehicle is in a safe operating state to perform the test). In certain embodiments, a passive test may be performed by monitoring the vehicle to determine when the test conditions are occurring, and observing the normal vehicle operations during those conditions. For example, a test may involved observing the transient powertrain response during a shift between 2^{nd} and 3^{rd} gear when the engine of the vehicle is between 1800 and 2200 RPM. Such a test could be quickly performed using an active test, but the vehicle operating conditions may not be amenable to an active test. In the example, the test may be performed passively, for example by monitoring the vehicle operating conditions until the test conditions occur, and the passive test collects the data as it occurs (and/or just after it occurs), which may not occur as quickly as an active test but does not disturb the operations of the vehicle. In certain embodiments, a test operation may maintain a rolling buffer of data, for example the last 30 seconds of the engine speed and gear selection, allowing the test to capture recent historical data once the conditions of the test occur. In certain embodiments, additional information related to the test may be kept in the rolling buffer as well to support the test. Example data for a test may include initiating data (e.g., data setting forth the trigger conditions for the test to be allowed and/or under which the test will be reliable), the actual test data (e.g., the parameters observed to determine the outcome of the test—for example whether the transient behavior is within proper operation), and/or test contraindications (in the example—if the gear is shifted back out of 3^{rd} gear before the test is complete, and/or if the engine speed goes outside the 1800-2200 RPM range). In certain embodiments, a test may be performed passively for a time period, and escalated to an active test after a specified period, upon the vehicle reaching a condition where an active test is allowable, or the like.

Without limitation to any other aspect of the present disclosure, diagnostic operations as utilized herein should be understood broadly. Diagnostic operations include any operations to determine the proper operating state of a component, system, application, sensor, actuator, etc. on the vehicle. In certain embodiments, diagnostics may be more formally integrated into the vehicle systems than a test, for example with formal state parameters being reported, fault codes set, diagnostic codes set, etc., although this need not be the case. In certain embodiments, a diagnostic may be performed periodically, on an ongoing basis, after certain events (e.g., 50,000 miles since the last operation of the diagnostic, once per day, once per trip, etc.), and/or a diagnostic may be performed as desired (e.g., a service person may run particular diagnostics, for example as a part of a fault tree analysis, due to particular observed conditions or operating behaviors of the vehicle, or the like). In certain embodiments, there may be significant overlap between some operations that could be characterized as a test or a diagnostic, and the actual labeling of such operations as a “test” or “diagnostic” is not limiting to the present disclosure. Diagnostic operations may also be performed passively or actively, as set forth in the test description preceding.

Without limitation to any other aspect of the present disclosure, maintenance operations as utilized herein should be understood broadly. Maintenance operations typically include operations that change some aspect of the vehicle, such as a trim (e.g., available parameters for adjustment within the permissions scope of the particular user, typically changing non-fundamental control features of the vehicle, for example the default performance law (e.g., “economy” or “sport”), a maximum cruise speed within allowable ranges, or the like), a calibration (e.g., available parameters for adjustment that may change fundamental control parameters—for example the gains of a PID controller, maximum vehicle power, etc., but still enforced within the scope of permissions of the user), enabling or disabling of features on the vehicle, reconfiguration of aspects of the vehicle (e.g., the network address of an end point, the selection of certain control algorithms (e.g., torque governor vs. speed governor for primary vehicle motive power control), changing connectivity and/or permissions for end points, applications, or flows on the vehicle, resetting parameters on the vehicle (e.g., system time, state of health for a battery, vehicle mileage indications, resetting adaptable controller values, etc.), or the like. Maintenance operations include adjustments that are made during MTDM operations that will persist after the MTDM operations are complete (and/or after an initial stage of MTDM operations are complete). In certain embodiments, a maintenance operation does not change an aspect of the vehicle. For example, a maintenance operation that switches the vehicle to “Power Governor B” may not switch the governor, for example if the governor is already at the B setting, but the confirmation of the state in that example serves as the maintenance operation.

Collectively, operations to support monitoring, testing, diagnostics, and/or maintenance herein are referenced as MTDM operations. It will be understood that certain operations can be characterized as one or more of monitoring, testing, diagnostics, or maintenance, depending upon the context and purpose of the operations, the state of the vehicle, the location of the vehicle (e.g., mission operation on the road, at a service location, during a manufacture of the vehicle, upfitting the vehicle at a bodybuilder or OEM, etc.), the terminology and/or philosophy of the relevant user (e.g., one manufacturer may consider a particular operation to be a testing operation, and another one may define that same operation as a diagnostic), and the maturity of the vehicle and related vehicles (e.g., a particular test may be utilized for a period, and then be re-characterized as a diagnostic after a period of time, after the test is determined to be valuable as a diagnostic, etc.). Operations herein that are referenced as an MTDM operation (or analogously, components referenced as an MTDM system or similar terminology) include at least one operation (an/or support at least one operation) that can be characterized as a monitoring, testing, diagnostic, or maintenance operation, but do not need to include all of these, and further may include operations that could be characterized within more than one MTDM category depending upon the context and/or purpose of such operations. The specific terminology utilized is not limiting,

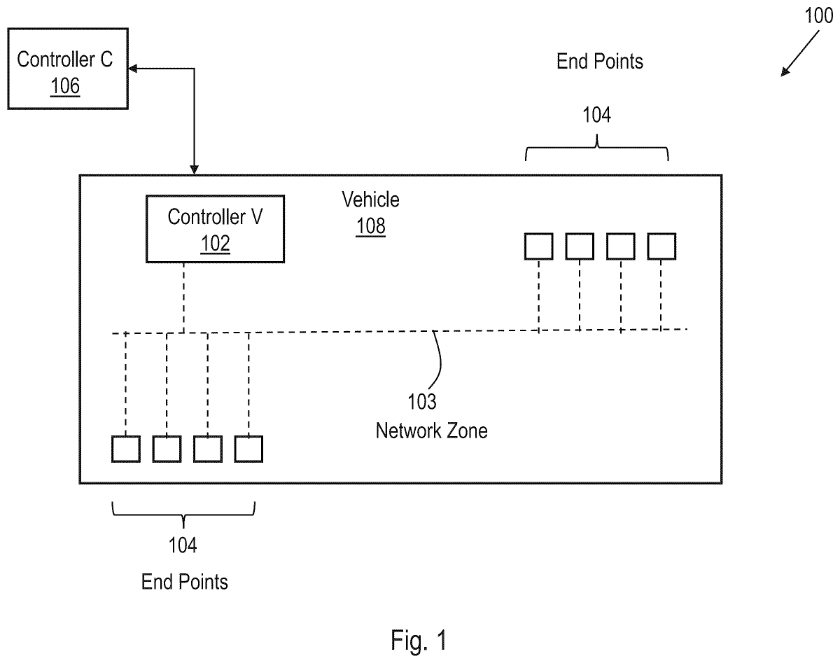

Aspects of the present disclosure provide for systems and/or procedures to support implementation of flexible and highly configurable monitoring, testing, diagnostic, and/or maintenance operations on mobile applications, such as vehicles. Embodiments herein are applicable to any vehicle having at least one network zone utilized for various end points (e.g., vehicle controllers, sensors, actuators, and/or other components coupled to a network on the vehicle). In the example of FIG. 1, an example system 100 includes a vehicle 108 having a single network zone 103 (e.g., an Ethernet network, CAN, or any other type of network) with a number of end points 104 communicatively coupled through the network, and a vehicle side controller (Controller_V) 102 that performs various operations to implement operations herein, including providing for control of vehicle communications, including communications between end points on the network, communications between end points and external devices (e.g., to the cloud controller (Controller C), and or to other external devices such as tools communicatively coupled to the vehicle, internet websites or web based tools, an operator interface as a part of the vehicle, a mobile application, or the like).

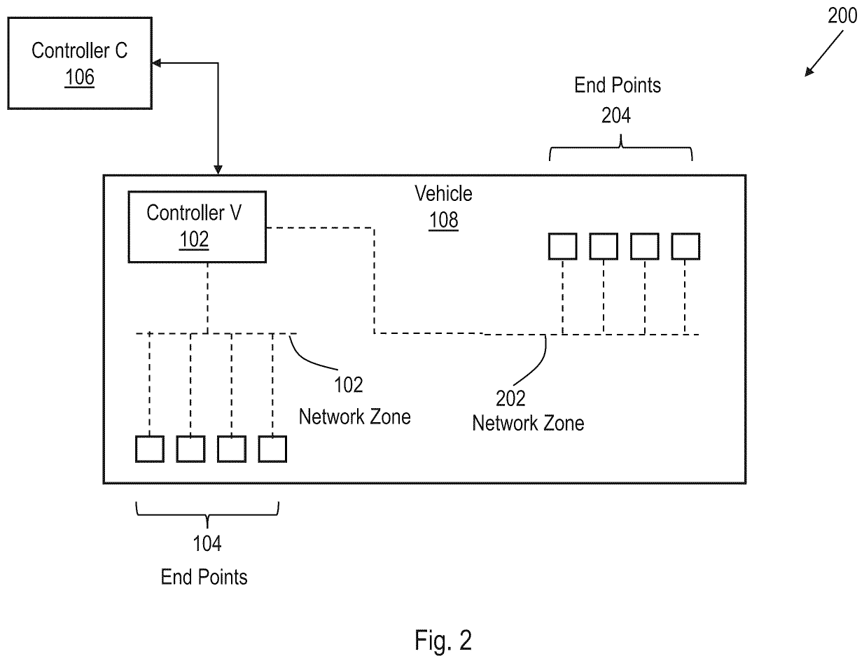

In the example of FIG. 2, an example system 200 includes a vehicle 108 having more than one network zone 103, 202, where the second network zone 202 may be different type of network than the first network zone (e.g., an Ethernet, CAN, LIN, etc.), which may be a different hardware layer than the first network zone (e.g., a first Ethernet network and a second Ethernet network), which may be a separate logical network than the first network zone (e.g., a virtual network 202 operating on the same hardware layer as the first network zone 103, for example to separate communications for secured end points, flows, applications, or the like), and/or a combination of these. The network zone configuration of the vehicle is non-limiting, for example all relevant end points 104, 204 on the vehicle 108 may be on a single network zone, or on a mix of network zones, including network zones of different types, protocols, communication parameters, or the like. Embodiments herein support the creation, rollout, and implementation of MTDM operations without regard to the location of end points on the network zones. Embodiments herein allow the user to focus on what operations they want performed on the controllers 102, 106, without having to know the network locations of end points, or the communication parameters of end points (e.g., data rates, resolution, units, how the data is packaged into network messages, where to get data that is not owned by particular end points, etc.).

The controllers 102, 106 are depicted as a single device for clarity of illustration, but the controllers 102, 106 may be a distributed device, and/or aspects of the controllers 102, 106 may be embodied, in whole or part, on and/or as a part of any computing device, sensor, actuator, logic circuit, or the like on the vehicle, in the cloud, and/or at least selectively or intermittently in communication with these. In certain embodiments, the controllers 102, 106 and/or aspects thereof, may be embodied in different forms at different times, for different operations, and/or at different operating conditions. For example, a manager of a controller may be positioned, in whole or part, on a user device during certain operations—for example the MTDM interface manager may be embodied, at least partially, on a user device during user operations to create, modify, and/or rollout an MTDM workflow—for example to improve responsiveness of the system for the user, to reduce resource utilization such as memory resource and/or communication resources, or the like.

The example Controller V 102 is capable to manage communications between end points on the vehicle 108, including for example end points on different networks, utilizing different network protocols, utilizing different data types (e.g., formatting of data, units represented in the data, etc.), and/or utilizing different sampling rates (e.g., utilizing up-sampling or down-sampling of data, for example to match algorithm expectations for an end point, application, flow, etc. utilizing the data, to filter out some dynamic response in the data for any reason, or the like). The example Controller V 102 is further capable to enforce permissions for end points 104, 204 to communicate data, to publish available data, to request data, to see data, to subscribe to available data, or the like. The example Controller V 102 is further capable to enforce external communication plans, for example provided as a part of a policy, to manage which end points 104, 204 are capable to communicate with external devices, to utilize network resources, to utilize memory and/or buffering resources, to request or provide data to external devices, or the like. In certain embodiments, the external communication plan may include limitations on data utilization, limitations on external communication devices (e.g., available transceivers, hardware ports such as an OBD port, Bluetooth communications, WiFi communications, etc.), routing of communications between the end point and the external device (e.g., pathing through various networks, end points, transceivers, or the like). In certain embodiments, the Controller V 102 is further capable to determine priorities between end points, applications, flows, individual communications, or the like, in response to operating conditions such as the availability of and/or status of external communication resources, the availability of memory storage, or the like. In certain embodiments, the Controller V 102 is further capable to determine operational responses to off-nominal conditions, for example changing the routing of data and/or responsible controllers/end points on the vehicle in response to the loss of an end point, in response to a fault condition, or the like. Without limitation to any other aspect of the present disclosure, the Controller V 102 may utilize circuits, controllers, managers, models, computing devices, and/or any other aspects provided in the following recited references to perform aspects of operations herein. The example operations supported for each of the following disclosures is a non-limiting example. The recited references include: SYSTEM, METHOD, AND APPARATUS TO SUPPORT MIXED NETWORK COMMUNICATIONS ON A VEHICLE (U.S. Ser. No. 17/027,167, now issued U.S. Pat. No. 11,411,823, filed on 21 Sep. 2020) (SONA-0006-U01) (on vehicle network communications management); SYSTEM, METHOD, AND APPARATUS TO EXTRA VEHICLE COMMUNICATIONS CONTROL (U.S. Ser. No. 17/027,187, now issued U.S. Pat. No. 11,228,496, filed on 21 Sep. 2020) (SONA-0007-U01) (communications management to external devices); SYSTEM, METHOD, AND APPARATUS FOR MANAGING VEHICLE DATA COLLECTION (U.S. Ser. No. 17/195,589, now issued U.S. Pat. No. 11,538,287, filed on 8 Mar. 2021) (SONA-0010-U01) (providing for data collection operations); SYSTEM, METHOD, AND APPARATUS FOR MANAGING VEHICLE DATA COLLECTION (U.S. Ser. No. 17/833,614, filed on 6 Jun. 2022) (SONA-0012-U01) (providing for automated vehicle operations, data collection, and/or remote control); and/or UNIVERSAL INTRUSION DETECTION AND PREVENTION FOR VEHICLE NETWORKS (PCT/US2022/046292, filed on 11 Oct. 2022) (SONA-0013-WO) (security support for externally connected vehicles). Each of the foregoing patents and/or applications is incorporated herein by reference in the entirety for all purposes.

Embodiments herein provide for one or more of: improved detection of defects or off-nominal conditions occurring on a vehicle; improved fidelity of detecting and identifying the source of off-nominal conditions; allow for secure sharing of knowledge across vehicles and/or allowing for knowledge determined for a first vehicle to otherwise benefit other vehicles that share an aspect with the first vehicle; allow users that are experts in vehicle diagnostics, reliability, service, and/or maintenance to configure and deploy monitoring, testing, diagnostic, and/or maintenance flows to a vehicle, without requiring that the user have sophisticated knowledge about the vehicle configuration, network topology, location and/or naming of end points and/or data values, or the like; provide for a reduced likelihood that a recall will be required for an event (e.g., due to early detection, high fidelity definition of the issue, rapid correction of the issue, and/or rapid confirmation that the correction has resolved the issue); and/or provide for a reduced cost implementation of a recall where relevant (e.g., due to ease of deployment to vehicles, due to the ability to provide a same update to multiple vehicles having a number of distinct configurations, ease of confirmation that the update has been properly applied, etc.).

In certain embodiments, operations herein support rapid configuration of a vehicle, including for example: enabling or disabling a feature on the vehicle; changing a calibration on the vehicle; installing a new feature (e.g., a test, a diagnostic, a new feature for additional capability, a new feature for detection of future issues, a new feature for mitigation of detected or potential issues, etc.) on the vehicle, including potentially a codeless install (e.g., implementing the feature using triggers, data collection, data storage, automated operations, or the like, through a flexible data structure such as a policy change, without requiring a vehicle shutdown and/or a software update); adjusting inter-network and/or intra-network communication management on the vehicle; adjusting memory storage parameters for the vehicle; and/or adjusting external communications with end points of the vehicle.

In certain embodiments, operations herein can be performed at any point in the vehicle life cycle, for example during manufacture, finalizing the vehicle after manufacturer, application by an OEM, application by a body builder, application by a dealer, application by service personnel, application by a fleet manager, application by an operator, during an upgrade of the vehicle, during a change of ownership of the vehicle, and/or during a change of application of the vehicle (e.g., where the vehicle is changed to a new fleet, changing operations to a new duty cycle, etc.).

In certain embodiments, operations herein support better overall vehicle performance, reduced operating costs, and/or reduction of risk that address a number of challenges that are arising in the context of vehicle operations, including vehicle manufacture, service, support, operational management, or the like. Vehicles are being manufactured with an increasing number of sophisticated sensors; with various network configurations; an increased number of controllers or other end points on network(s) of the vehicle; with configuration variability of individual components (e.g., selected sensors, actuators, controllers, etc.) and/or of base vehicle configurations (e.g., network topology, network operations such as protocols, network speed capability, network security management, etc.) change over time including between models, model years, and/or even within a given model year; increased customization options for vehicle groups (e.g., a particular fleet), vehicle types (e.g., a high performance option for a model), and/or even individual users (e.g., the user wants to change HVAC behavior of the vehicle); and/or a proliferation of powertrain configurations for a given model (e.g., an ICE, hybrid, and/or EV version of a model). This proliferation of components, features, and/or configurations greatly increases the complexity of performing monitoring, testing, diagnostic, and/or maintenance (MTDM) operations, of determining the physical and/or data implementation of the vehicle, of determining fixes or updates that will work across vehicles, of a roll out of a fix, test, diagnostic, or configuration update to relevant vehicles, and/or of a confirmation that applied fixes, tests, diagnostics, and/or configuration updates were properly applied and/or corrected the targeted issue.

Previously known systems for performing MTDM operations for a vehicle suffer from a number of drawbacks. For example, the proliferation of vehicle components and/or configurations currently requires specific knowledge about the configuration of vehicles, end point locations/addresses and/or naming conventions, an understanding of which end points provide (and/or are capable to provide) which data aspects, the formatting and/or other operational information about data provided (e.g., data format, network communication/packet information, units utilized, data sampling rate, data latency, etc.), an understanding of which end points provide (and/or are capable to provide) operational capability (e.g., an actuator responsive to commands), and/or an understanding of the formatting and/or other operational information about operational capability provided. In another example, the high rate of change in vehicle capabilities and/or configurations increases the cost of delays in diagnostic, corrective, and/or configuration update operations, as a given vehicle accordingly spends a greater percentage of its life cycle with reduced capability for diagnostic, testing, and/or configuration operations due to delays in confirming proper operation and/or correcting improper operation. Accordingly, one or more non-optimal aspects are introduced, such as: capability delay (e.g., delay to install or implement new capability, reducing the commercial value and/or utility of the vehicle); increased risk is incurred (e.g., installing a capability that is not fully tested); mitigation costs are increased (e.g., reduced capability to provide a corrective action, and/or time delay to implement the corrective action); and/or a combination of these. In another example, previously known systems to provide certain types of capability, such as re-calibrating fundamental operations (e.g., a new sensor table), adding or removing features from the vehicle, changing network communication control of the vehicle, and/or combinations of these (e.g., installation of an updated sensor may implicate several of these operations), require a number of undesirable aspects of the system, for example requiring collaboration between multiple experts (e.g., a vehicle network expert for that particular vehicle, a service expert to understand the operational issue and how to detect it), and/or requiring a software update on the vehicle (e.g., increasing the cost of the operation, for example to enforce a shutdown of the vehicle and/or prevent certain types of operations during the install, and/or introducing the risk of disabling the vehicle, for example if the installation is not successful).

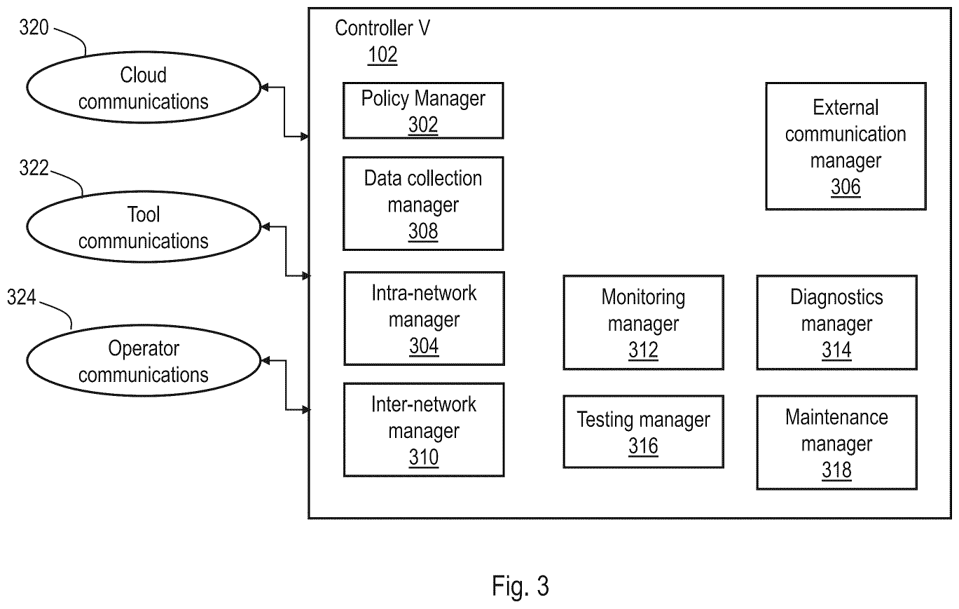

Referencing FIG. 3, an example Controller V 102 is schematically depicted to support MTDM operations for a vehicle and/or a group of vehicles. The Controller V 102 is depicted as a single device as an end point on the vehicle, but the Controller V may be distributed among several devices, included in whole or part on another end point of the vehicle, or the like. The group of vehicles may be related in any manner, for example vehicles having a certain application, flow, end point, sensor, actuator, feature, etc., and/or vehicles having a shared relationship such as vehicles that are a part of a particular fleet, vehicles sold by a particular dealer, vehicles provided by a particular manufacturer, vehicles subscribing to a particular system, or the like. The example Controller V 102 includes a policy manager 302 that interprets a new or updated policy (and/or an initial policy, for example at a time of manufacture of the vehicle), which may include a number of aspects such as permissions descriptions (e.g., to access data, end points, flows, applications, features, external communications, etc.), data collection descriptions, trigger evaluation descriptions (e.g., where the trigger condition may be based on any data available on the vehicle, and/or may include timers, conditions before the trigger evaluation is performed, multiple trigger evaluations in parallel and/or serial, etc.), actions to be performed based on trigger evaluations (e.g., data collection operations, actuator commands, set point commands, alternative calibration sets, etc.), or the like. In certain embodiments, the policy may be provided as a cloud communication 320 (e.g., where the policy is passed down to the vehicle from the cloud) and/or as a tool communication 322 (e.g., where the policy is provided by a manufacturer, OEM, dealer, body builder, service person, etc., utilizing a tool communicating with the vehicle). The policy manager 302 and/or utilization of a policy to provide command communications between the Controller V 102 and Controller C 106 is a non-limiting implementation example.

The example Controller V 102 further includes a data collection manager 308, which may be responsive to the current policy(ies), which controls various aspects of data collection such as identifying end points, managing publication and/or subscription to data, determining data formatting, units, sampling rates, etc., determining disposal of collected data (e.g., storage, communication, data life cycle management, redundancy management, prioritization, etc.), and/or providing permissions information to be utilized by other managers of the controller 102. The Controller V 102 further includes an intra-network manager 304, for example providing control of end point communications on a given network, including for example which end points are permitted to provide or request data, network utilization of end points, configuration of packets for utilization between networks, or the like. The Controller V 102 further includes an inter-network manager 310, for example allowing for communications to seamlessly flow between network zones, potentially according to associated permissions (e.g., associated with the potential communications, such as according to an associated end point, flow, application, feature, etc.), which may include edge gateways or other components to facilitate communications between networks of different types and/or different protocols. In certain embodiments, the inter-network manager 310 configures communications for the receiving end point, including for example providing communications at the expected sampling rate, data resolution, data units, packaging network packets in an expected manner, etc. The Controller V 102 further includes an external communication manager 306, for example allowing end points to communicate with external devices (e.g., including the Controller C 106), receive and provide operator communications 324, configuring the routing of communications between end points and external devices, enforcing permissions, and/or performing intrusion detection or other security operations for the vehicle.

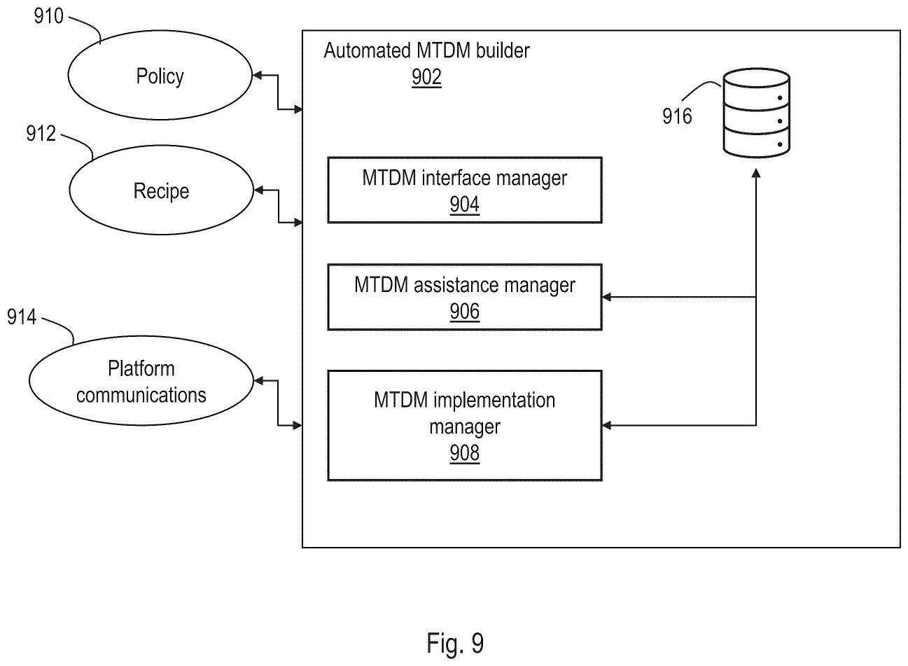

The example Controller V 102 further includes a monitoring manager 312 that performs monitoring operations for the vehicle. Monitoring operations can be applied to any aspect of the vehicle, including for example: proper operation of a sensor or actuator; proper operation of a flow (e.g., a related group of functionality on the vehicle, for example as a logical subsystem to perform certain operations on the vehicle); proper operation of an application or feature (e.g., a feature of the vehicle, for example for control of the HVAC, speed control of the vehicle, support for ADAS operations, etc.); and/or to confirm that a vehicle does (or does not) have a failure, bug, or other aspect, for example related to observations on the vehicle, on an offset vehicle, related to a component installed on the vehicle, or the like. Monitoring operations can include observing any data value on the vehicle, comparing the data values in a sophisticated manner to detect underlying conditions and/or to utilize determined indicators (e.g., comparing data values to thresholds, determining an index or other value from a number of data values, performing a statistical analysis on data values, etc.). In certain embodiments, monitored data values may relate to network functionality (e.g., network traffic monitoring), vehicle functionality (e.g., monitoring operational parameters of the vehicle), or any other aspect of the vehicle having related data available somewhere on an end point of the vehicle. Monitoring operations may be performed in response to a trigger evaluation of any type, for example data values to be watched before the monitoring operations are commenced, data values to be watched that indicate the end of the monitoring operation, data values to be watched at any stage of MTDM operations, data values to be watched to determine transitions between stages of MTDM operations, and/or data values to be watched on an ongoing basis after other MTDM operations are completed. Monitoring operations may include storing the data values, whether utilizing long-term storage, and/or using a rolling buffer or other technique to allow capturing of recent data after a trigger condition is met. Monitoring operations may be repeated, for example repeating a monitoring of a particular operation, utilization of a feature, etc., a pre-determined number of times, and/or over a set period of time (e.g., each time event X occurs during the month of September). The utilization of data values for monitoring and/or trigger evaluations related to the monitoring, may include any type of mathematical, statistical, and/or logical operation on the data values, including for example processing values to determine time derivatives, comparing to ranges or thresholds, determining averages, determining inflection points, etc. In certain embodiments, monitoring operations can be configured, adjusted, and/or sent to the vehicle by any authorized user by a tool (e.g., a service tool, manufacturing tool, engineering tool, OEM tool, dealer tool, etc.) in communication with the vehicle, and/or through an interface with the Controller C 106, for example logging in to a web portal, using a proprietary application (e.g., stored on or accessible to a local computing device for the user), and/or using a mobile application to interface with the Controller C 106 to set up and/or implement the monitoring operations. In certain embodiments, the monitoring interface provides dropdown menus or other interface elements to allow the user to see accessible data, and to utilize the data in defining monitoring and/or trigger evaluation operations. An example monitoring interface may be implemented by an MTDM interface manager 904 (reference FIG. 9 and the related description), which may be positioned on, at least in part, an automated MTDM builder 902, which may be positioned on, at least in part, and/or in communication with the Controller C 106. In certain embodiments, data provided to the user is configured, listed, identified, or the like, in a format that is easily accessible to the user—for example allowing the user to select “Oil Temperature” without any knowledge of which sensor is utilized, which end point the sensor is associated with (e.g., where the sensor may be an end point, and/or the sensor may be associated with a controller that acts as the end point for the sensor), translating to desired units for the user, allowing the user to configure data formatting and/or sampling rates (and/or providing the user with options for these), etc.

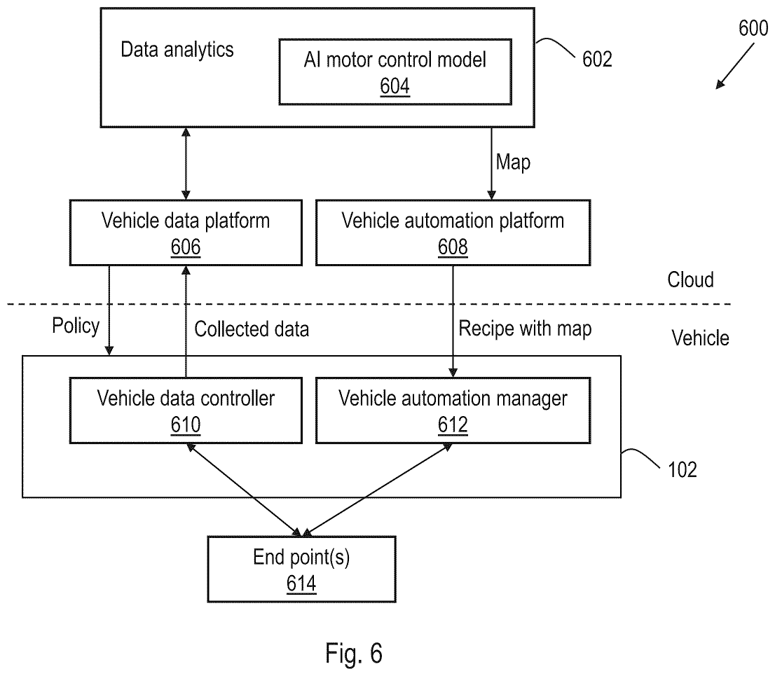

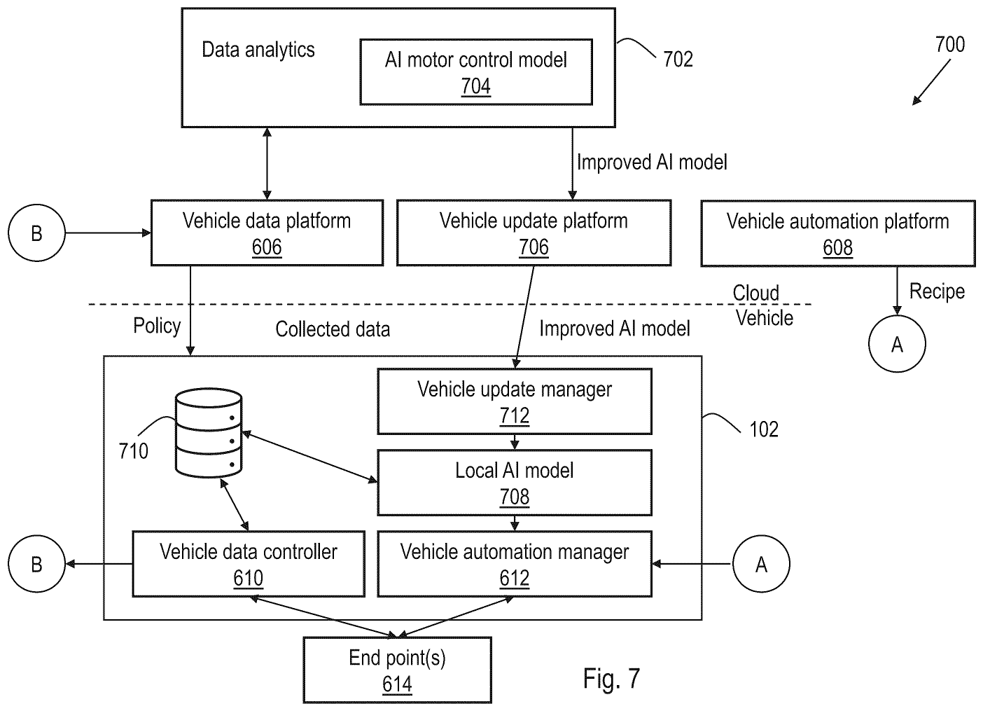

In certain embodiments, monitoring operations, trigger evaluations, or the like, can be saved in modules or other discrete elements, allowing the user to re-use all or a part of monitoring operations in later vehicle function elements of any type (e.g., any MTDM operations for various embodiments of the present disclosure). In certain embodiments, monitoring operations, trigger evaluations, and/or portions of these may be stored in a library (e.g., on data store 916 in the example of FIG. 9) to be accessible to the user for re-use and/or sharing with other users. In certain embodiments, the associated instructions for the monitoring operations are provided to the vehicle for implementation, for example as a policy where the operations can be performed without any software update to the vehicle, but any other implementation is contemplated herein. In certain embodiments, monitoring operations may be provided as a recipe (e.g., reference FIGS. 6-7 and the related description), and/or may implemented, at least in part, in response to a map or model provided by a vehicle automation platform 608. In certain embodiments, the associated instructions for the monitoring operations can be provided to an entire group of vehicles, for example selectable according to criteria provided to the user (e.g., vehicle IDs, models, model years, owner information, fleet constituent, etc.), where adjustments for each specific vehicle are provided automatically (e.g., a data value in the monitoring operation may be provided by distinct components or end points across the vehicles, where the policy for each vehicle is configured for that vehicle, and/or interpreted by the policy manager on each vehicle, allowing the operator to ignore and/or not even be aware of the differences), which may be limited according to the permissions of the user (which may be distinct relative to different vehicles of the vehicle group), and which may be provided as a policy update and/or as an additional policy to be serviced by the vehicle(s).

The example Controller V 102 further includes a testing manager 316 that performs testing operations for the vehicle. In certain embodiments, the difference between testing operations and monitoring operations depends upon the actions being performed, for example actively controlling aspects of the vehicle (e.g., adjusting set points, articulating actuators, etc.) may be understood as a testing operation for certain embodiments, while mere data collection and/or further processing of data may be understood as a monitoring operation for certain embodiments. In certain embodiments, operations that are monitoring operations versus testing operations may be determined according to conventions for the user, an entity associated with the user, a regulation, an industry standard, or the like. The specific terminology of a given set of operations as monitoring operations or testing operations is not limiting. Testing operations may include any functional aspects as set forth herein, including at least: collection of data; processing, formatting, up-sampling/down-sampling, and/or compressions of data; storage and/or communication of data including life cycle management and/or prioritization of the data; adjusting any control value (e.g., a limit, a set point, a defined range, a calibration value, etc.) on the vehicle; utilizing trigger evaluations to commence, end, and/or progress (e.g., from a first stage to a second stage) a testing operation; and/or changing a network control parameter (e.g., permissions for end points, communication between networks, resource utilization limits, etc.). Similarly, a monitoring operation may include any one or more of these operations. In certain embodiments, testing operations may be implemented on a user interface, in a similar manner to the monitoring interface. In certain embodiments, for example to enforce particular conventions for testing and/or monitoring operations, the available data and/or operations that can be commanded from the testing interface may be distinct from the available data and/or operations that can be commanded from the monitoring interface, even for a particular user having a particular set of permissions associated with MTDM operations herein.

The example Controller V 102 further includes a diagnostics manager 314 that performs diagnostic operations for the vehicle. In certain embodiments, the difference between testing and monitoring operations and diagnostic operations depends upon the actions being performed. In certain embodiments, operations that are testing or monitoring operations versus diagnostic operations may be determined according to conventions for the user, an entity associated with the user, a regulation, an industry standard, or the like. In certain embodiments, a diagnostic operation outputs a state value, an index value, or another value describing whether an aspect of the vehicle (e.g., a sensor, actuator, end point, flow, application, feature, etc.) is in a failed condition, off-nominal condition, suspect condition, or the like. In certain embodiments, a diagnostic operation is performed that interacts with a formal diagnostic system of the vehicle (e.g., OBD, reported fault codes, etc.). In certain embodiments, a diagnostic operation is performed that interacts with an informal diagnostics system of the vehicle (e.g., silent fault codes, engineering parameters, etc.), that determines state values of components for analysis by service personnel, and/or operations performed to determine whether conditions of any type are present on the vehicle, for example to support troubleshooting operations, fault tree analysis, risk analysis, determination of whether a recall is indicated and/or to plan the recall response, and/or for any other purpose as desired by the user. In certain embodiments, diagnostic operations may be implemented on a user interface, in a similar manner to the monitoring interface. In certain embodiments, for example to enforce particular conventions for testing, diagnostic, and/or monitoring operations, the available data and/or operations that can be commanded from the diagnostic interface may be distinct from the available data and/or operations that can be commanded from the monitoring interface, even for a particular user having a particular set of permissions associated with MTDM operations herein.

The example Controller V 102 further includes a maintenance manager 318 that performs maintenance operations for the vehicle. In certain embodiments, the difference between testing/monitoring/diagnostic operations and maintenance operations depends upon the actions being performed. In certain embodiments, a maintenance operation includes operations associated with changing components on the vehicle, upgrading components on the vehicle, adjusting operations in response to wear (e.g., a temperature sensor response profile that changes with age), resetting values in response to service and/or maintenance events, notifying a vehicle controller that a component has been changed or upgraded, or the like. In certain embodiments, maintenance operations involve operations that are intended to be long term or permanent changes to the operations of the vehicle—for example changing a calibration value on the vehicle, enabling or disabling a feature of the vehicle, installing a new feature on the vehicle (e.g., a feature provided by trigger evaluations and automated operations, which can be accomplished without a software update, and/or a feature implemented in a software update), removing a feature from the vehicle, changing a set point and/or operational value (e.g., max speed or power) on the vehicle (which may be provided as a calibration change, or by any other operations), and/or changing operations of the vehicle (e.g., network configurations, network management operations, etc.). In certain embodiments, maintenance operations can include any calibration changes, tuning changes, reconfiguration of components, or the like. In certain embodiments, maintenance operations may be implemented on a user interface, in a similar manner to the monitoring interface. In certain embodiments, for example to enforce particular conventions for testing, diagnostic, monitoring, and/or maintenance operations, the available data and/or operations that can be commanded from the maintenance interface may be distinct from the available data and/or operations that can be commanded from the monitoring interface, even for a particular user having a particular set of permissions associated with MTDM operations herein.

Example and non-limiting monitoring operations include one or more aspects such as: vehicle-wide monitoring (e.g., any parameter on the vehicle), event driven monitoring, monitoring at the vehicle and/or fleet level (and/or any other vehicle group), monitoring for expected and/or unexpected events or anomalies, and/or determination of outliers in the monitoring (e.g., distinguishing an event that does not exceed a threshold for automatic determination, but is determined due to the statistical description of the data in response to analogous data on the vehicle, on an offset vehicle, and/or within a vehicle group); and/or includes both reactive and/or predictive monitoring.

Example and non-limiting testing operations include one or more aspects such as: integration with an external test management system (e.g., an OEM or manufacturer test management system, for example performing tests and/or providing data utilized in the external test management system); performing functional testing (e.g., does the feedback performance of an operational aspect meet performance criteria, such as power response in a transition); performing feature testing (e.g., monitoring operations of a feature to ensure it is operating at the times intended, and providing the response intended, testing competing versions of a feature, and/or testing whether a feature change operates as intended); and/or operating as a programmable traffic generator/simulator (e.g., simulating certain parameters on the vehicle, to test other features on the vehicle, and thereby reduce the cost of testing and/or isolating other aspects of the vehicle of the testing for the feature of interest).

Example and non-limiting diagnostic operations include one or more aspects such as: providing a virtual and/or cloud based formal diagnostic support (e.g., OBD); utilizing single step and/or multi step diagnostic operations; providing and/or adjusting diagnostic operations from a variety of locations (e.g., in-vehicle, near vehicle, remote, web-based, etc.); and/or providing diagnostics on demand (e.g., a service operator commands a diagnostic to be performed) and/or self-directed (e.g., a latent diagnostic installed on the vehicle, that activates based on a trigger evaluation of any type).

Example and non-limiting maintenance operations include one or more aspects such as: reconfiguring an aspect of the vehicle (e.g., changing a component or end point, and/or changing a location thereof); tuning an aspect of the vehicle (e.g., adjusting an operating parameter to get desired behavior, such as the values of controller gains, set points, error determinations, response sequencing, etc.); and/or providing a calibration for any component, end point, flow, application, or feature of the vehicle.

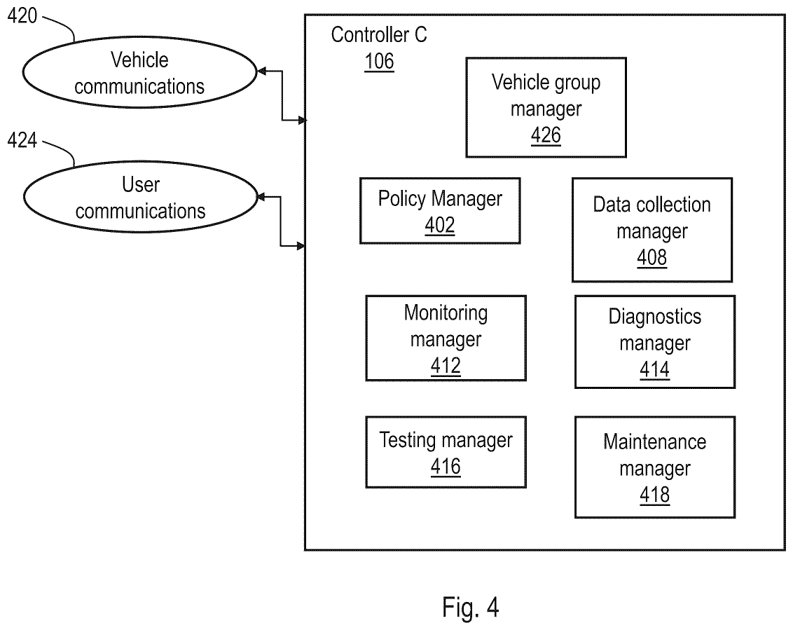

Referencing FIG. 4, an example Controller C 106, for example a supporting controller in the cloud, on a tool, or on another external device at least intermittently in communication with the vehicle (and/or Controller V 102) is schematically depicted. The example Controller C 106 may perform any one or more operations as set forth in regard to Controller C 106 throughout the present disclosure, including for example providing user interfaces to one or more users for MTDM operations. In certain embodiments, a Controller C 106 is configured to perform one or more operations as set forth for Controller V 102 (e.g., where the vehicle controller offloads certain operations to the cloud controller), and/or a Controller C 106 may embody, in whole or part, an automated MTDM builder 902 a data analytics component 602, 702, a vehicle data platform 606, a vehicle automation platform 608, and/or a vehicle update platform 706 (e.g., reference FIG. 7 and the related description). An example Controller C 106 communicates with cloud side users using user communications 424. The example Controller C 106 may provide long term data storage, configured data access, implement a web portal and/or a mobile application for interfacing, check permissions for various users, and/or provide policies or policy updates to vehicles (e.g., using the policy manager 402, providing vehicle communications 420 to provide policies, collect data, etc.). In certain embodiments, the Controller C 106 includes a vehicle group manager 426, allowing a user to provide MTDM operations to a group of vehicles, to execute rollout operations for MTDM operations to a selected group of vehicles, to select vehicles, to collect data from the vehicle group, and/or to perform analysis on data from vehicles of the vehicle group to determine potential off-nominal operations, to determine outlier results (e.g., from monitoring operations), or the like.

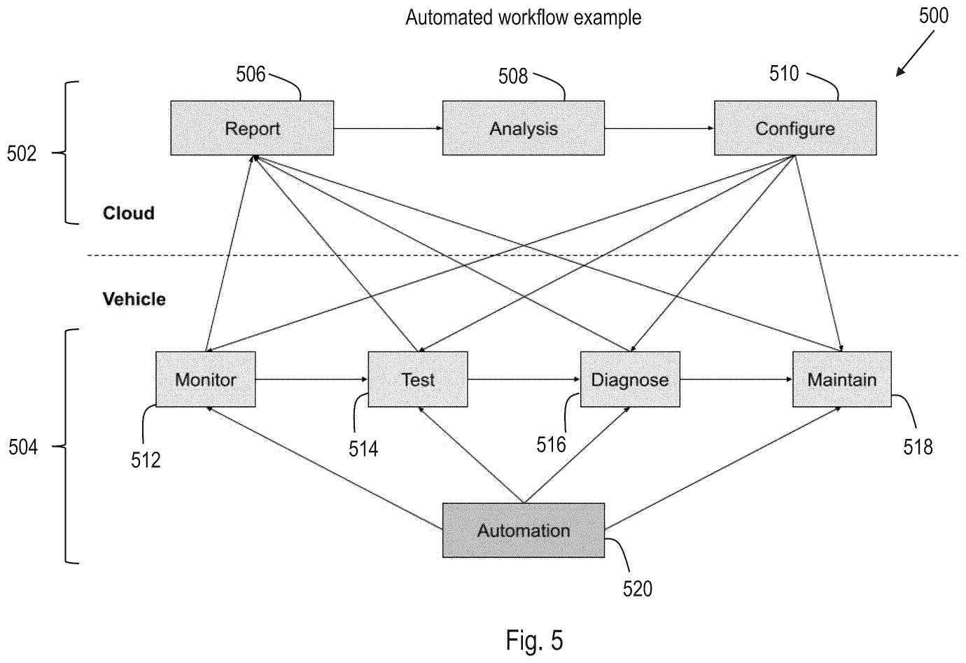

Referencing FIG. 5, an example schematic flow diagram 500 illustrates operations of an automated workflow according to embodiments herein. In the example of FIG. 5, operations above the line (“cloud” 502, in the example) are performed by one or more devices that collectively embody Controller C 106, and operations below the line (“vehicle” 504, in the example) are performed by one or more devices that collectively embody Controller V 102. The example Controller C 106 performs one or more of: a report operation 506 (e.g., allowing a user to access results from MTDM operations herein, including for example highlighting off-nominal data, outlier data, requested data, etc.); an analysis operation 508 (e.g., applying defined analysis to data to determine whether faults, failures, or other conditions are present on vehicles, to check vehicle configurations, to check calibrations or other settings on vehicles, to build, improve, and/or implement vehicle versions of models, recipes, and/or maps, etc.) where the analysis operation 508 may include performing pre-determined analysis and/or user-defined analysis of the data from the vehicle(s). The example Controller C 106 performs a configure operation 510, for example providing policies, calibration changes, feature enablement changes, or the like, in response to detected conditions, user requested changes, or the like as set forth throughout the present disclosure. The example Controller V 102 performs MTDM operations as set forth throughout the present disclosure, and includes an automation work element 520 that implements changes, for example as provided by the configure operation of the Controller C 106, to complete the vehicle configuration changes and/or implement the features or other operations that are being added or removed. In certain embodiments, the automation work element 520 provides for direct communication, control, and/or updating of end points, applications, flows, controllers, or the like, on the vehicle to execute portions of the MTDM operations. The division of operations between the Controller C 106 and Controller V 102 of FIG. 5 is a non-limiting example, and certain operations may be switched, in whole or part, from the depicted division of the controllers, and/or certain operations may be performed by both the Controller C 106 and Controller V 102. In certain embodiments, the division of work elements between Controller C 106 and Controller V 102 may be dependent upon operating conditions, for example according to ongoing vehicle operations, the access method of the user to the system (e.g., mobile application, a tool communicatively coupled to the vehicle, and/or a web portal access), and/or available connectivity between the vehicle and the cloud or tool. It will be understood that the cloud side 502 may additionally or alternatively be implemented, in whole or part, by a tool such as a service tool, engineering tool, manufacturing tool, OEM tool, body builder tool, and/or dealer tool, for example in communication with the vehicle by any available communicative coupling (e.g., WiFi, Bluetooth, direct physical connection such as an OBD port or a proprietary port, through a cellular connection, and/or through a WAN such as over the internet).

In certain embodiments, any individual work element (e.g., reference FIG. 5), and/or the entire MTDM workflow, may be automated in whole or part. In certain embodiments, MTDM operations may be performed by a user with a single device, for example a mobile device, without any other equipment (e.g., cables, communicative connections, access to an OBD port, access to a key to update software on the vehicle, etc.). Vehicle side MTDM operations are depicted schematically in the workflow 500 as a monitor work element 512, a test work element 514, a diagnose work element 516, and/or a maintain element 518.

An example embodiment includes one or more automated test sequences described as a workflow via a user interface to Controller C 106, where the test sequences are deployed to selected vehicles for implementation. In certain embodiments, the test sequences may be stored as a vehicle recipe, for example utilized to label and identify data for analysis, and/or for re-use of the automated test sequence and/or portions thereof. An example automated test sequence includes one or more aspects such as: triggering the test in response to a vehicle operating condition; triggering the test from a remote message from a user; triggering the test from the result of another test, diagnostic, monitoring, and/or maintenance operation; providing resulting data from the test to the cloud; adjusting test sequences in response to the data sent to the cloud (and/or analysis thereof); implementing a test suite incorporating a number of tests; deploying the test(s) to vehicles; and/or tracking test results (e.g., events of the test being performed and/or data related thereto).

An example embodiment includes one or more automated diagnostic sequences described as a workflow via a user interface to Controller C 106, where the diagnostic sequences are deployed to selected vehicles for implementation. In certain embodiments, the diagnostic sequences may be provided as a policy update and/or an added policy. An example automated diagnostic sequence includes one or more aspects such as: operating a diagnostic tree with nodes (e.g., operated as a state machine, or otherwise transitioning between nodes of the tree); operating a diagnostic in response to a vehicle condition; operating a diagnostic in response to an outcome of an earlier diagnostic; following a diagnostic tree to determine a root cause of a failure, unexpected event, anomalous event, etc.; providing resulting data from the diagnostic to the cloud; analyzing the diagnostic results and/or related data; and/or adjusting the diagnostic sequence in response to the diagnostic results.

An example embodiment includes providing a software defined component. For example, any component of the vehicle (e.g., a sensor, actuator, end point, flow, application, controller, feature, etc.) is monitored according to one or more trigger policies (and/or any MTDM operations set forth herein), collected data is provided to the cloud, the collected data is analyzed and a new configuration is determined, and the new configuration is implemented on relevant vehicle(s) to update the operations of the component. In certain embodiments, a new feature may be created as a codeless feature at a first time, and implemented as a coded feature at a later time (e.g., to reduce the number of software updates, while also managing the size of the policy or other implementing data structure for the feature). In certain embodiments, the MTDM operations, including without limitation providing a software defined component, is repeated over the lifecycle of the vehicle, to continually improve operations of the vehicle, configure the vehicle for the specific operator and/or conditions of the vehicle, to manage compliance with regulations, to provide the vehicle with the benefit of continuous improvement determinations made over the life span of the vehicle, or the like.

An example embodiment includes creating an automated diagnostic sequence, and implementing the automated diagnostic sequence on selected vehicles. The example embodiment includes creation of an automated diagnostic sequence, for example utilizing a diagnostic user interface of Controller C 106 (e.g., by an MTDM interface manager 904), and storing the automated diagnostic sequence as a recipe than can be re-used and/or shared with other users. The example embodiment includes building a diagnostic tree—for example a state machine and/or algorithm with progressive staging—from the recipe and/or other data structure capturing the automated diagnostic sequence. The example embodiment includes implementing the automated diagnostic sequence on selected vehicle(s), for example providing the diagnostic as an actionable workflow and/or as a policy to the vehicle for implementation. In certain embodiments, the automated diagnostic sequence can interact with, and/or include, testing operations, monitoring operations, and/or maintenance operations (e.g., allowing the system to immediately correct the problem if detected, for example even if cloud communications are unavailable at the time).

Referencing FIGS. 6-7, example embodiments are depicted showing MTDM operations performed using a cloud server (e.g., above the “cloud” line) and vehicle controller (e.g., below the “vehicle” line). The example embodiments include an AI model that provides continuous improvement of operations to diagnose or detect issues, to mitigate issues, and/or to re-configure the vehicle to resolve or respond to issues. In the example of FIG. 6, a data analytics component 602 utilizes an AI motor control model 604 that builds a model for a motor on the vehicle (e.g., an electric motor having a significant workload, for example to provide motive power, operate a fan, provide accessory power such as for steering, etc.), and provides a recipe and/or map for control of the motor on the vehicle, which is implemented by the vehicle automation manager 612. The AI motor control model 604 provides ongoing analysis of the motor control, including for example accounting for aging or degradation of the motor, the specific duty cycle of the motor on the vehicle, or the like, and periodically updates the model of the motor, the recipe, and/or the map for implementing control in response to the model. The Controller V 102 in the example of FIG. 6 includes a vehicle data controller 610 that manages data collection from end points 614 responsive to the policy and/or MTDM operations as set forth herein. The Controller V 102 in the example of FIG. 6 includes a vehicle automation manager 612 that manages automated responses of the vehicle responsive to the policy and/or MTDM operations as set forth herein, for example commanding, updating, and/or monitoring end points 614 of the vehicle.

In the example of FIG. 7, the data analytics component 702 includes an AI motor control model 704, where all or a portion of the AI model is present on a vehicle controller (as local AI model 708), allowing for more rapid and specific response and improvement for that vehicle. The example of FIG. 7 includes a vehicle side AI model component 708 that operates the model, providing for greater capability on the vehicle to improve the motor operations, for example where the Controller V 102 includes or has access to sufficient computing resources to operate the model. In certain embodiments, the model provided to the vehicle may be simplified relative to the cloud version of the model, for example utilizing reduced resolution, modeling step times, parameter inputs, or the like. In certain embodiments, a recipe and/or map for the motor control may additionally or alternatively be provided, for example from the vehicle automation platform 608 to the vehicle automation manager 612. The example of FIG. 7 includes an optional shared data store 710, and a vehicle update manager 712 that manages updates to the vehicle, for example including updates provided as an automated maintenance operation.

The examples of FIGS. 6 and 7 provide for a highly capable AI model to be developed for any component, actuator, sensor, motor, application, flow, feature, or the like, of the vehicle, and to apply the benefits of the highly capable AI model for rapid and/or real-time implementation in the vehicle, while preserving vehicle computing resources which are generally more limited than computing resources available off vehicle. The data analytics component 602 is capable to pull whatever information is helpful to the model (e.g., motor duty cycle, operating conditions, temperatures, voltages, current values, operating speeds, phase determinations, etc.), including parameters utilized to determine appropriate update cycles (e.g., odometer values, operating times, fault conditions, WiFi APN status, etc., which may be utilized as trigger conditions to update the model and/r to check the model for potential updates that may be useful), and to provide the model, recipe, and/or map to the vehicle. The example of FIG. 7 allows for the model, or a simplified model, to be utilized directly on the vehicle which can improve response times to changes in the operating state of the motor (or other component) and/or to the operating expectations of the motor (e.g., changes in the duty cycle, environment, etc.). The examples of FIGS. 6-7 utilize a motor control as the framework for the illustration, but any aspect of the vehicle may benefit from analogous operations and all aspects of the vehicle are contemplated herein to benefit from a similar utilization of a data analytics component 602 and/or AI model component. In certain embodiments, an example component includes an ultrasonic sensor utilized to support ADAS operations, for example providing near-field object detection (e.g., to support automated navigation such as parking, and/or to support the operator such as providing them with a picture of the nearby surroundings). The provided examples are non-limiting.

Automotive manufacturers and suppliers lack reliable ways to monitor performance of vehicle components post sales in the real world, but at the same time are constantly seeking ways to improve the performance of various complex features, applications, flows, or the like, such as Advanced Driver Assistance Systems (ADAS) in vehicles. One example area for improvement is sensor tuning, which involves improving the performance of the various sensors and actuators that enable ADAS features such as automated parking or obstacle detection. This kind of detection is heavily dependent on the sensitivity of the sensors and how the output of those sensors is interpreted, for example to detect curbs.

Current approaches to sensor tuning often rely on limited data sources and often require cumbersome FOTA (e.g., over the air software installation) campaigns to iteratively increase the ADAS performance on vehicles in a timely and efficient manner. An example embodiment includes a software defined component that collects and sends to the cloud multiple sources of data, including signals, camera data, sensor data, and logs. The data can then be correlated in the cloud using advanced algorithms and machine learning techniques, allowing us to quickly and accurately identify areas for improvement in sensor performance.

The output in form of a low weight optimized sensor and actuator performance mapping can then be deployed to the vehicle immediately enabling real-time updates to improve ADAS performance. Embodiments herein to support MTDM operations make it possible for automakers and suppliers to efficiently keep their components up to date even after production and optimized to any possible scenario, including scenarios that were not contemplated or understood at the time of manufacture. Operations include dynamically and precisely gathering data of interest from multiple sources such as signals, camera data, sensor data and logs; conveniently run scheduled diagnostic routines or sensor calibration campaigns from the cloud; and quickly deploy new component performance mappings to target ECUs, allowing such embodiments to efficiently keep components up to date without costly FOTA campaigns.

Again referencing FIG. 3, an example system includes a Controller V 102 having a policy manager 302 that interprets a policy (e.g., as a cloud communication 320 and/or tool communication 322) including an automated escalation protocol for a vehicle monitoring operation, a data collection manager 308 that interprets vehicle data responsive to the vehicle monitoring operation, and a monitoring manager 312 that detects a vehicle event in response to the vehicle data (e.g., determining the vehicle event has occurred in response to trigger evaluation(s) provided in the policy), and to implement the automated escalation protocol in response to determining the vehicle event is active. An example automated escalation protocol provides for progression through MTDM actions, for example providing for progression through monitoring, testing, diagnostic, and/or maintenance operations in response to the trigger evaluations provided in the policy, transitioning between operations, repeating operations in a controlled manner, or the like.

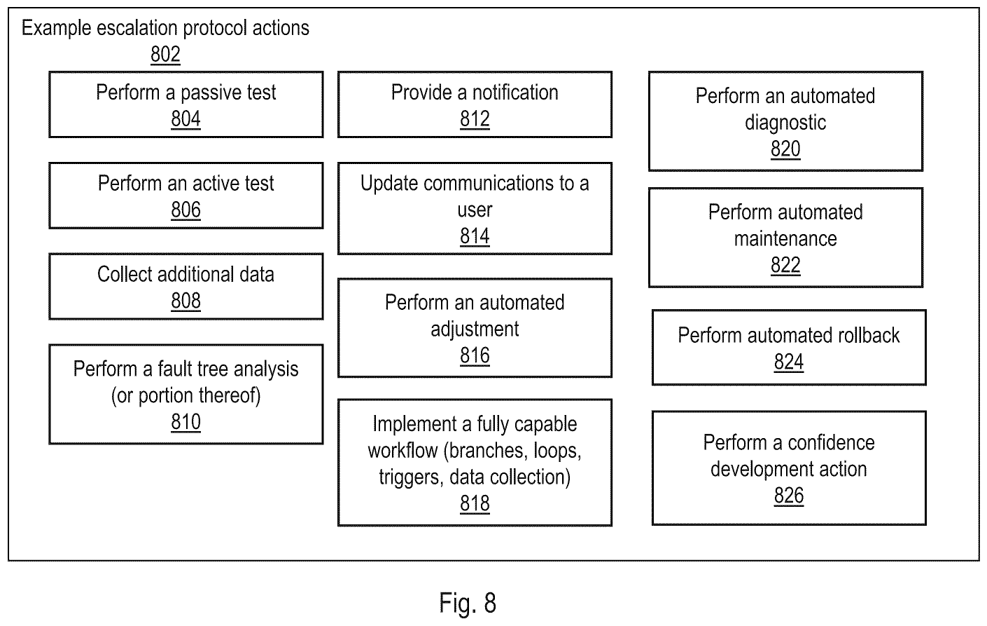

Referencing FIG. 8, example and non-limiting actions that may be performed as escalation protocol actions 802 include operations such as: performing a passive test 804; performing an active test 806; collecting additional data 808 (e.g., collecting a first set of data until the vehicle event is detected, and collecting a second set of data in response to the detected event, for example to develop an understanding of the causes of the event, to improve future vehicle response during the event, to determine if related conditions are also present due to the event, to collect data to support diagnostic, testing, continuous improvement operations, or the like); to develop, deploy, and/or implement a fault tree analysis 810 (or portions thereof); to provide a notification 812 (e.g., to any user defined in the policy, for example service personnel, to an administrator of the Controller C, to a manufacturer, to an owner or operator of the vehicle, etc.); to update communications to a user 814 (e.g., updating the user on the status of MTDM operations, progression of MTDM operations, significant determinations made during MTDM operations, etc.); to perform an automated adjustment 816 (e.g., allowing for immediate vehicle response to detected conditions, for example to mitigate consequences of the event, etc.); to perform an automated diagnostic 820 (e.g., detect the condition, and then perform a diagnostic prepared for execution in response to the condition); to perform an automated maintenance 822 (e.g., changing a vehicle configuration, calibration, trim, etc., in response to the detected event, and/or in response to further data collection, testing, or diagnostics performed in response to the detected event); and/or to perform a confidence development action 826 (e.g., collecting further related data that can tend to confirm or rule out a condition believed to cause the event, to determine if related conditions are also present in the vehicle, etc.). An example escalation protocol action 802 includes performing an automated rollback 824, for example to return the vehicle to a condition before an automated adjustment 816—for example in response to determining that the automated adjustment was not effective, to determining that an underlying condition potentially indicated by the detected event is not actually present on the vehicle, to determining that the automated adjustment 816 has caused another issue with the vehicle, and/or to remove a temporary fix on the vehicle that has been obviated by a more permanent fix, etc.). An example escalation protocol action 802 includes a fully capable workflow 818, for example allowing a number of MTDM operations to support the escalation action with a number of actions sequenced according to various trigger evaluations, branched operations, looping and/or recursive operations, and/or to develop further information through additional data collection operations.

An example system includes a data collection manager 308 that performs at least a portion of the automated vehicle data collection operations of an automated escalation protocol. An example system includes a diagnostics manager 314 that performs at least a portion of automated diagnostic operations of an automated escalation protocol. An example system includes a testing manager 316 that performs at least a portion of automated testing operations of an automated escalation protocol. An example system includes a maintenance manager 318 that performs at least a portion of automated maintenance operations of an automated escalation protocol. An example system includes an external communication manager 306 that performs at least a portion of notification operations to user(s), where the notification operation forms a part of the automated escalation protocol. In certain embodiments, the managers 302, 308, 312, 314, 316, 318 may be supported by cloud side managers 402, 408, 412, 414, 416, 418, for example to store data, perform certain processing and/or analysis operations, to provide communications to users using communication avenues that may not be generally available to the vehicle, or the like.

Example and non-limiting notifications that may be utilized as a part of an automated escalation protocol include one or more of: an indication of the detected vehicle event; values determined during at least one of an automated diagnostic operation or an automated testing operation; actions performed during the automated escalation protocol implementation; or a status of the implementation of the automated escalation protocol. Example and non-limiting notifications include one or more of: the detected vehicle event, test parameters of the automated testing operation, test results of the automated testing operation, or a status of the automated testing operation. Example and non-limiting notifications include one or more of: the detected vehicle event, diagnostic parameters of the automated diagnostic operation, diagnostic results of the automated diagnostic operation, or a status of the automated diagnostic operation. Example and non-limiting notifications include one or more of: a notification that the automated diagnostic operation has occurred or is pending, a summary of key results from the automated diagnostic operation, next steps planned according to the automated escalation protocol, or a progression of the automated escalation protocol.

Example and non-limiting automated vehicle data collection operations include an operation to collect selected vehicle data associated with the detected vehicle event. Example and non-limiting selected vehicle data includes data such as: data associated with the detected vehicle event; confirmatory data utilized to confirm the detected vehicle event and/or an associated condition; and/or related vehicle condition data (e.g., condition X may be an indicator that condition Y is also present, where the related vehicle condition data is data that checks for and/or confirms the presence of condition Y). Example and non-limiting automated testing operations include a confirmatory test (e.g., confirming that the event is real, and/or a related condition is actually present), and/or a related vehicle condition test. Example and no-limiting automated testing operations include a post test, for example performing the testing operations on past data, for example stored in a rolling buffer of relevant data and performed at a later time, for example performing a post test once a trigger condition for the automated test is met, on recently collected data stored in the rolling buffer (and/or further including ongoing data collected during the test operations). Example and non-limiting automated maintenance operations include one or more of: a vehicle tuning operation; a vehicle calibration operation; a vehicle reconfiguration operation; and/or a feature enablement operation. In certain embodiments, automated maintenance operations are performed in response to a confidence value associated with the detected vehicle event, and/or a confidence value associated with detection of an underlying condition of the vehicle that is related to the detected vehicle event (e.g., determined due to additional testing and/or diagnostic operations). In certain embodiments, automated maintenance operations are performed in response to an impact value associated with the detected vehicle event (and/or underlying condition of the vehicle), for example where maintenance operations are more strongly applied, or more quickly applied, where an impact of the condition significantly affects the ability of the vehicle to perform mission functions of the vehicle. In certain embodiments, automated maintenance operations are performed in response to an impact value associated with the automated maintenance operations, for example where maintenance operations that may significantly affect the ability of the vehicle to perform mission functions of the vehicle may be delayed or deferred until the vehicle is in a condition where those operations will not impact the vehicle, and/or in comparison to the impact value of the underlying condition (e.g., maintenance operations that have a higher risk of impacting the vehicle mission may be deferred until the impact value of the underlying condition is greater than the potential impact of maintenance operations—for example if the maintenance action limits the maximum power of the vehicle, that maintenance operation may be deferred until the underlying condition degrades mission performance and/or is creating a risk of damage to the vehicle, etc.).

In certain embodiments, operations of the escalation protocol are performed according to permissions defined in the policy. Permissions may define data that can be collected, resource utilization limits, actuators that can be controlled, vehicle operating condition limits (e.g., certain operations limited to low power or idle operation, time of day limitations, network utilization limits (e.g., limiting operations when the vehicle network is relatively busy supporting mission operations for the vehicle), data than can be published or otherwise provided by the escalation operations, parameter limits (e.g., the cruise control set speed can only be set within a certain range by the escalation operations), or the like. Permissions may be related to the authorization given to the user, device, flow, application, an entity related to the user, or the like, that provides, requests, and/or enables the implementation of the escalation protocol. In certain embodiments, the permissions examples and implementation relates to any MTDM actions as set forth throughout the present disclosure.

An example automated maintenance operation is performed in response to a status of the vehicle within a selected vehicle group, for example to allow for a progression of operations on the vehicles, allowing the system to defer maintenance on later vehicles in the group until the impact on early vehicles in the group is determined and/or confirmed. In certain embodiments, the maintenance operations for a group of vehicles may be limited to a small group of vehicles, wait for analysis of impact and/or checking for issues introduced by the maintenance operation, and then rolled out to the entire group. In certain embodiments, for example where a group of vehicles is very large, the maintenance operations may utilized several stages of the rollout, for example 1 vehicle, then 10 vehicles, then 100 vehicles, before the maintenance operation is performed on the entire group, allowing for managing the risks of implementation, utilizing learning from the early vehicles to configure the maintenance operations, or the like. An example automated maintenance operation is performed in response to an issue scope value for the detected vehicle event. The issue scope value provides a lever to determine how many vehicles are affected—for example an issue that is unique to a particular vehicle may be implemented in one way (e.g., just performing the maintenance operation when indicated), but an issue affecting a large group of vehicles may be implemented in another way (e.g., a staged rollout, and/or including a greater amount of collected data, diagnostics, and/or testing, to provide greater confidence that the issue is well understood before beginning a roll out to additional vehicles). An example automated maintenance operation is performed in response to a maintenance classification for the automated maintenance operation, for example adjusting the implementation based on the type of maintenance (e.g., which systems are affected, whether rollback will be available, whether the mission might be affected, etc.), and/or based on how many other vehicles have a similar maintenance classification and accordingly how many vehicles are likely to have a similar issue and/or impact from the maintenance operation.

An example maintenance manager performs a rollback operation in response to the vehicle response value indicating that the automated maintenance operation did not resolve the detected vehicle event. An example automated escalation protocol includes an alternative action to be utilized in response to the automated maintenance operation not resolving the detected vehicle event. Example and non-limiting alternative actions include one or more of: an alternative test action, an alternative diagnostic action, an additional monitoring action, and/or an additional maintenance action. An example maintenance manager adjusts the alternative action or selects the alternative action (e.g., from a group of actions, which may be related to various potential outcomes for monitoring, testing, and/or diagnostic operations) in response to the vehicle response value (e.g., indicating the detected event and/or underlying condition was resolved, or not, by the maintenance action).

An example monitoring manager determines MTDM outcome results in response to the automated escalation protocol (e.g., determining if the issue was resolved, and/or if the maintenance action provides an acceptable configuration for the vehicle), and the external communication manager provides the MTDM outcome results to a second vehicle (e.g., allowing the implementation on the second vehicle to benefit from the observation of the MTDM actions on the first vehicle). An example external communication manager interprets MTDM outcome results from a second vehicle, and adjusts the automated escalation protocol on a first vehicle in response to the MTDM outcome results from the second vehicle.

Referencing FIG. 9, an example system includes an automated MTDM builder 902 that includes an MTDM interface manager 904 that implements an MTDM interface, and to exchange communications (e.g., as platform communications 914) with a user device through the MTDM interface to facilitate building an MTDM workflow (e.g., any monitoring, testing, diagnostic, and/or maintenance action as set forth herein; an automated escalation protocol; and/or a full workflow such as schematically depicted in the examples of FIGS. 6-7 and the related description). The automated MTDM builder 902 further includes an MTDM assistance manager 906 that exposes an MTDM workflow library (e.g., stored on the data store 916, and/or stored in communication with the automated MTDM builder 902) to the MTDM interface, and an MTDM implementation manager 908 that prepares at least one of a policy, a recipe, a map, and/or a model in response to user interactions with the MTDM interface. The example MTDM workflow library includes one or more aspects such as: an escalation scheme object, a triggering logic object, or a notification logic object. The example MTDM workflow library additionally or alternatively includes one or more aspects such as: a monitoring workflow element, a testing workflow element, a diagnostic workflow element, a maintenance workflow element, and/or an automated escalation protocol. The example MTDM workflow library includes portions of any one or more of the foregoing, for example allowing users to leverage certain aspects of these that have been created earlier by the user, by another user, and/or provided as a template for certain MTDM actions. An example MTDM assistance manager 906 inserts an object from the MTDM workflow library into the MTDM workflow in response to a user selection operation (e.g., the user selects the object from a list, performs a drag-and-drop operation, selects the object using an API interface to the automated MTDM builder 902, etc.). An example MTDM assistance manager 906 creates a new object in the MTDM workflow library in response to a user object creation operation (e.g., allowing the user to hit a button or other executable object to capture a current workflow, and/or selected portions thereof, as a new library object for the MTDM workflow library). An example MTDM workflow includes one or more of: an MTDM workflow cycle; a branched operation; a looping operation; a trigger scheme; a rollback scheme; or an escalation scheme.

An example MTDM implementation manager 908 provides the at least one of the policy 910 or the recipe 912 to a vehicle in response to a user rollout operation (e.g., the user rollout operation may include a “Submit” button or similar interface object to implement a rollout, and/or may include requesting the rollout operation utilizing an API, a confirmation interface, or the like). An example MTDM implementation manager 908 provides the at least one of the policy or the recipe to a selected group of vehicles in response to a user rollout operation (e.g., where the user can define the selected group of vehicles formulaically, such as defining model numbers, years, relevant software versions or hardware components, vehicles having a certain detected event and/or underlying condition, vehicles owned by a particular entity, vehicles belonging to a particular fleet, etc.). An example MTDM implementation manager 908 provides the at least one of the policy or the recipe to the selected group of vehicles using a rollout schedule, where the rollout schedule includes a sequencing and/or a timing of provision of the at least one of the policy or the recipe to individual vehicles of the selected group of vehicles. For example, the user can define the rollout schedule, and/or the rollout schedule may be determined automatically, for example in response to the impact of the relevant detected event and/or underlying condition, the impact of the MTDM operations implemented by the rollout, or the like. An example MTDM implementation manager 908 customizes the at least one of the policy or the recipe for at least one individual vehicle of the selected group of vehicles, in response to properties of the at least one individual vehicle. For example, the selected group of vehicles may have variations in end point locations, hardware components and/or versions thereof, software components and/or versions thereof, or the like, where the MTDM implementation manager 908 adjusts the policy and/or recipe to account fo these differences, which may not relate to fundamental aspects of the MTDM operations, relieving the user of the burden of accounting for these issues for individual vehicles of the group. Example and non-limiting properties that may indicate customization include one or more of: end point names; end point locations (e.g., network address, network zone location, network zone type, etc.); an end point configuration (e.g., data sampling rate, network protocol, network packet configuration, data units, data resolution, data byte size, etc.); and/or a network configuration of the at least one individual vehicle (e.g., the selected zonal architecture, number and type of zones, connectivity between zones, etc.).

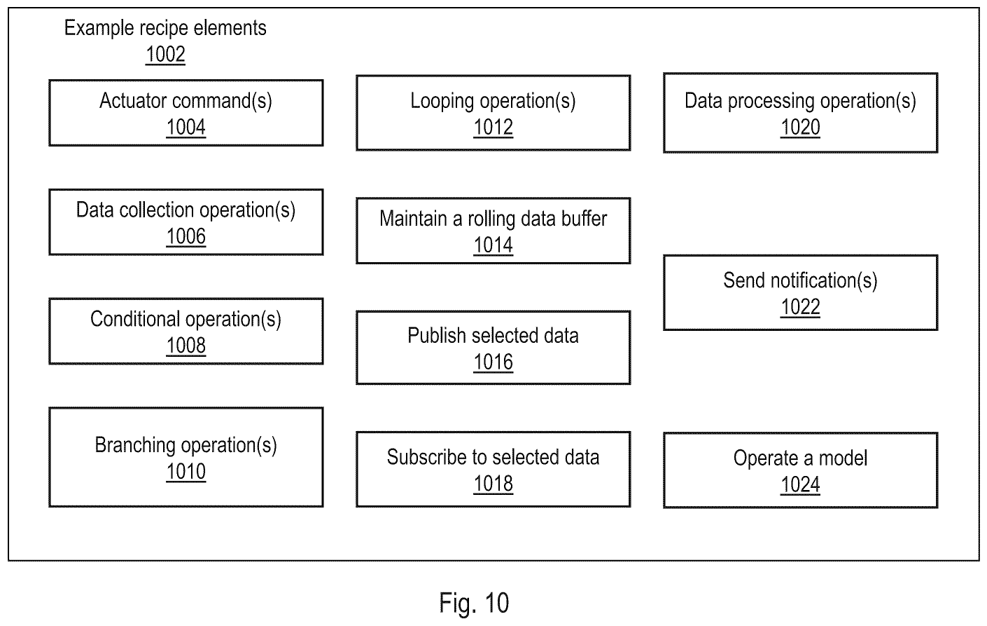

Referencing FIG. 10, example and non-limiting recipe elements 1002 are schematically depicted and include one or more of: an actuator command 1004, a data collection operation 1006, a conditional operation 1008 (e.g., an operation to be performed based on a trigger condition and evaluation), a branching operation 1010 (e.g., one or more aspects to be performed in parallel, and/or without dependency on each other), a looping operation 1012 (e.g., an operation to be repeated a set number of times, until another condition is met, on an ongoing basis, etc.), maintaining a rolling data buffer 1014 (e.g., allowing data generated before a trigger event occurs to be captured after the fact), publishing selected data 1016 (e.g., new data generated by MTDM operations, and/or data previously available but unpublished, which may now be of interest), subscribing to selected data 1018 (e.g., retrieving data that was previously available, but not received by a particular end point, application, flow, feature, etc.), a data processing operation 1020 (e.g., performing certain data processing, such as statistical analysis, compression, filtering, smoothing, removing outliers or noise, etc.), sending notifications 1022, and/or operating a model 1024 (e.g., a model provided by a user through the MTDM interface, by a cloud data analytics component, etc.).

Again referencing FIGS. 6-7, an example system 600, 700 includes a vehicle data platform 606 that provides a policy to a vehicle, where the policy includes an MTDM workflow element (e.g., a monitoring element, testing element, diagnostic element, maintenance element, and/or automated escalation protocol element), and a vehicle automation platform 608 that provides a recipe to the vehicle, where the recipe includes actions for an automated vehicle response. The example vehicle data platform 606 is further configured to receive collected data from the vehicle in response to an execution of at least one of the MTDM workflow element or the automated vehicle response by a controller 102 of the vehicle. An example MTDM workflow includes an arrangement between elements such as: a monitoring operation and a maintenance operation; a monitoring operation, a testing operation, and a maintenance operation; and/or a monitoring operation, a diagnostic operation, and a maintenance operation. An example MTDM workflow includes an arrangement between elements such as: a monitoring operation, a maintenance operation, and further monitoring operation; a monitoring operation, a testing operation, a further monitoring operation, and a further testing operation; a monitoring operation, a diagnostic operation, a further monitoring operation, and a testing operation; or a monitoring operation, a diagnostic operation, a further monitoring operation, and a further diagnostic operation. The example arrangements for an MTDM workflow are non-limiting, and any number of workflow elements may be arranged in any order according to any transition criteria between elements according to prescribed operations to detect and/or confirm vehicle events and/or underlying conditions, as set forth throughout the present disclosure. An example vehicle automation platform 608 provides a map to the vehicle, the map including a control model for at least one aspect of the vehicle. Example and non-limiting aspects of the vehicle for the control model include one or more of: a motor of the vehicle; a component of the vehicle; a powertrain of the vehicle; an end point of the vehicle; a flow of the vehicle; or an application of the vehicle. Without limitation to any other aspect of the present disclosure, a map provided to the vehicle by the vehicle automation platform 608 includes one or more of: tuning parameters for a control algorithm of the vehicle (e.g., gains, set points, error values, etc.); a control method selection for a control algorithm of the vehicle (e.g., which version of a control algorithm to utilize, enable, or disable); and/or model parameters. Example and non-limiting model parameters include one or more of: a virtual sensor of the vehicle, a feedforward component of a control algorithm of the vehicle, and/or a response model for an aspect of the vehicle. An example vehicle automation platform 608 provides the recipe and/or a performance map to the vehicle in response to the model (e.g., a cloud model) of the aspect of the vehicle. In certain embodiments, the vehicle automation platform 608 includes a vehicle model, which may be a functional equivalent of a cloud model, or a reduced version of the cloud model. An example cloud model includes an artificial intelligence model implemented by a data analytics component.

A number of procedures are described following. The example procedures are illustrative, and operations described therein may be reordered in whole or part, operations may be omitted, repeated, and/or operations set forth may be combined between procedures. One or more, or all, aspects of the described procedures may be performed by any system, manager, controller, platform, or other device as set forth throughout the present disclosure.

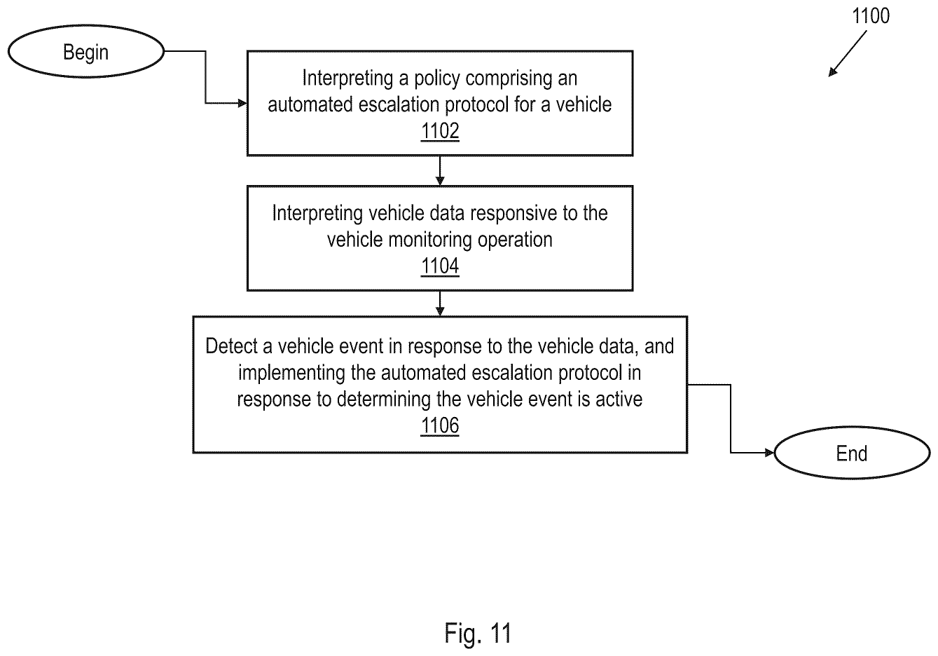

Referencing FIG. 11, an example procedure 1100 for implementing an automated escalation protocol is schematically depicted. The example procedure 1100 includes an operation 1102 to interpret a policy comprising an automated escalation protocol for a vehicle, an operation 1104 to interpret vehicle data responsive to the vehicle monitoring operation, and an operation 1106 to detect a vehicle event in response to the vehicle data, and implementing the automated escalation protocol in response to determining the vehicle event is active.

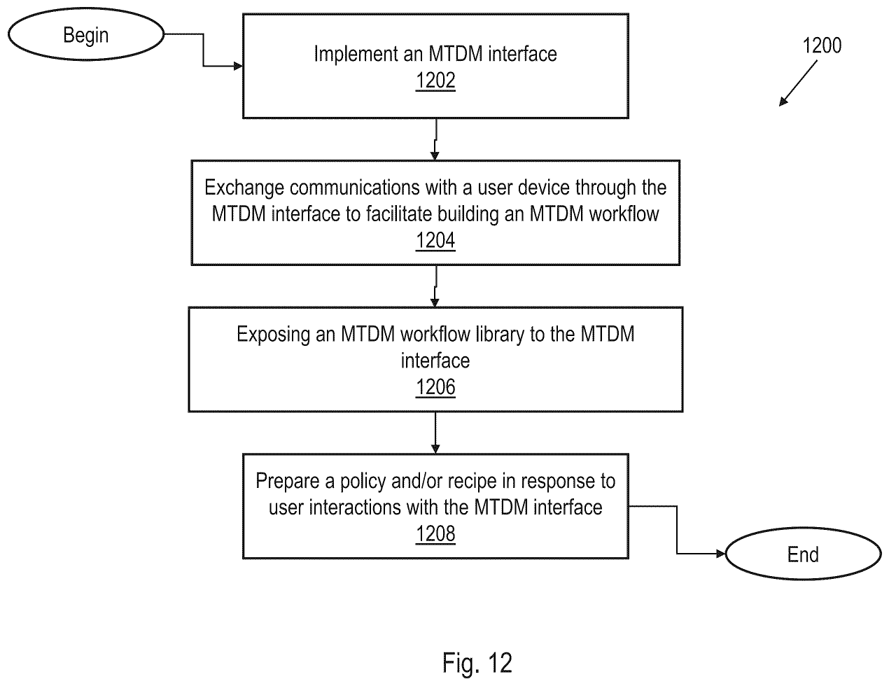

Referencing FIG. 12, an example procedure 1200 for implementing an MTDM interface is schematically depicted. The example procedure 1200 includes an operation 1202 to implement an MTDM interface, an operation 1204 to exchange communications with a user device through the MTDM interface to facilitate building an MTDM workflow, an operation 1206 to expose an MTDM workflow library to the MTDM interface, and an operation 1208 to prepare a policy and/or recipe in response to user interactions with the MTDM interface.

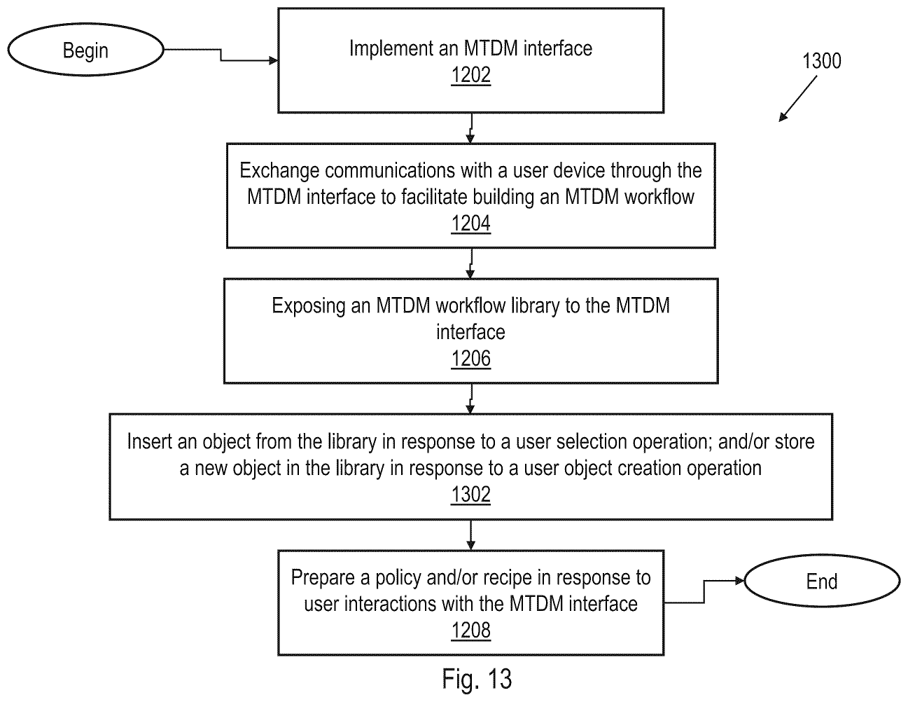

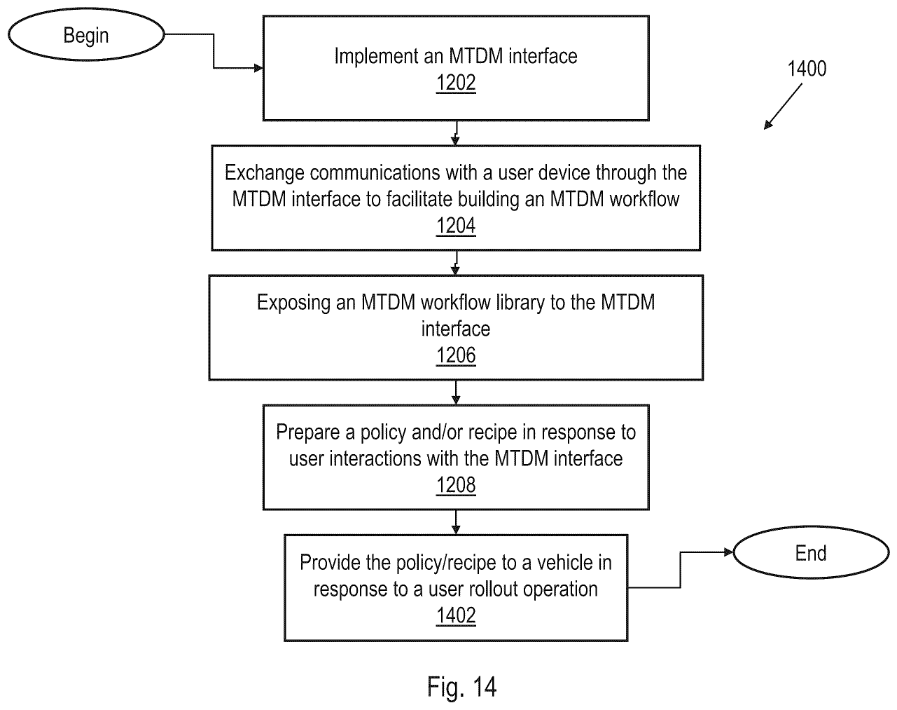

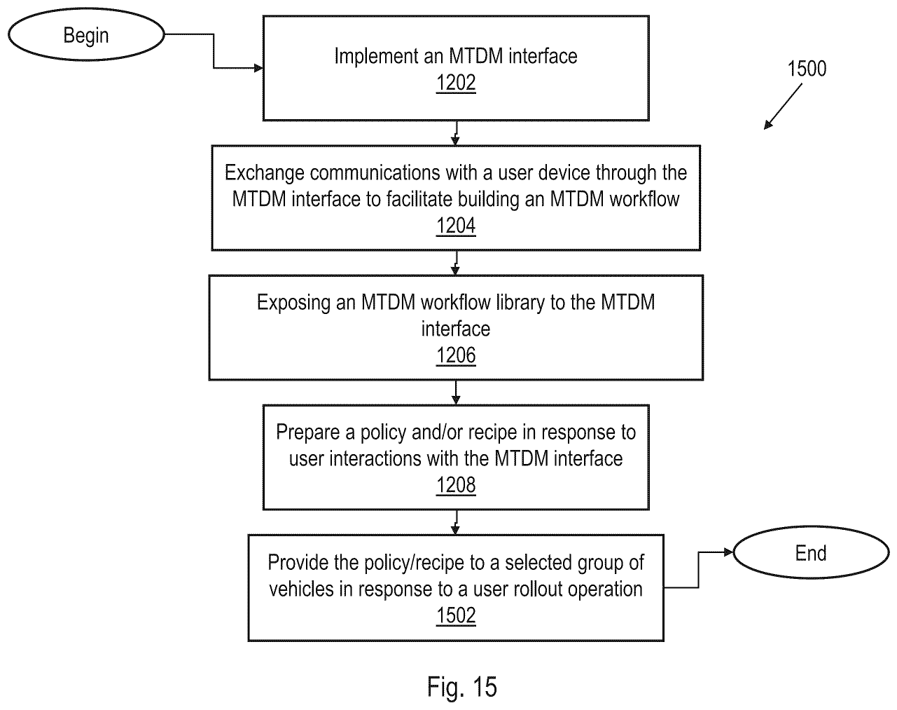

Referencing FIG. 13, an example procedure 1300 for implementing an MTDM interface is schematically depicted. The example procedure 1300, in addition to procedure 1200, further includes an operation 1302 to insert an object from the library in response to a user selection operation into the MTDM interface, and/or to store a new object in the library in response to a user object creation operation. Referencing FIG. 14, an example procedure for implementing an MTDM interface is schematically depicted. The example procedure 1400, in addition to procedure 1200, further includes an operation 1402 to provide the policy/receipt to a vehicle in response to a user rollout operation. Referencing FIG. 15, an example procedure 1500 for implementing an MTDM interface is schematically depicted. The example procedure 1500, in addition to procedure 1200, further includes an operation 1502 to provide the policy/recipe to a selected group of vehicles in response to a user rollout operation.

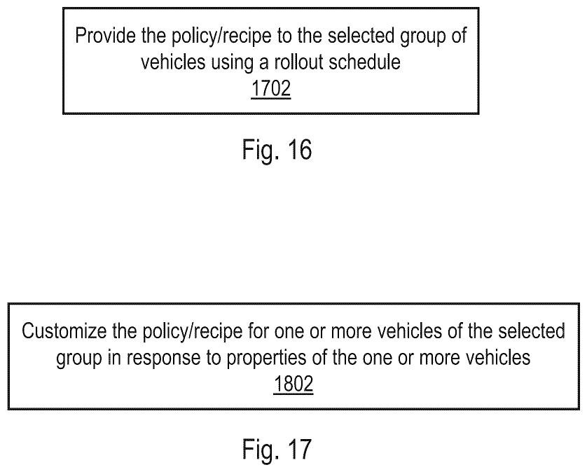

Referencing FIG. 16, an example procedure 1702 for a rollout operation is schematically depicted, including an operation to provide the policy/receipt to the selected group of vehicles using a rollout schedule. Referencing FIG. 17, an example procedure for a rollout operation is schematically depicted, including an operation 1802 to customize the policy/recipe for one or more vehicles of the selected group in response to properties of the one or more vehicles.

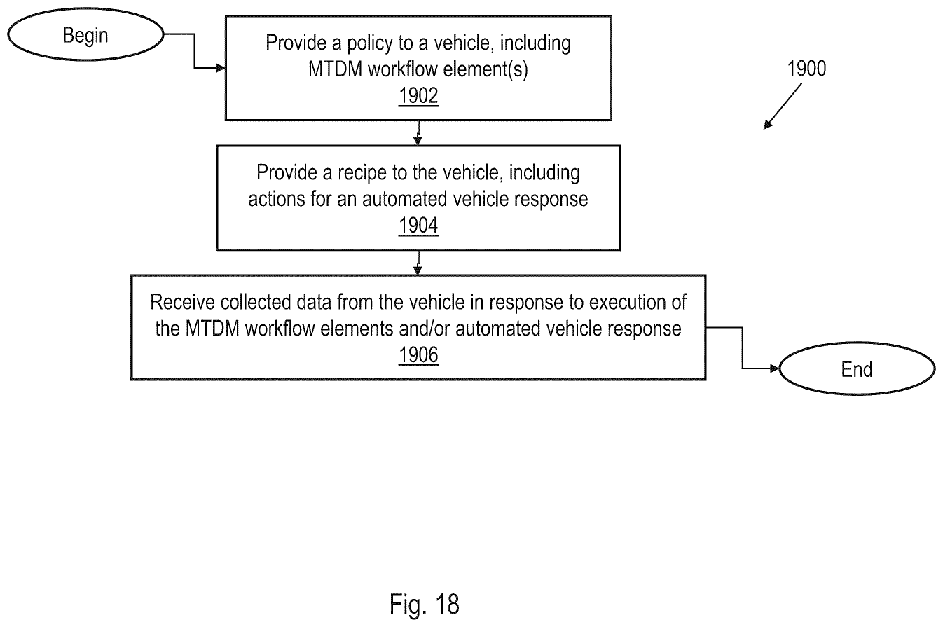

Referencing FIG. 18, an example procedure 1900 for a rollout operation is schematically depicted. The example procedure 1900 includes an operation 1902 to provide a policy to a vehicle, the policy including one or more MTDM workflow elements. The example procedure 1900 further includes an operation 1904 to provide a recipe to the vehicle, including actions for an automated vehicle response, and an operation 1906 to receive collected data from the vehicle in response to execution of the MTDM workflow elements and/or an automated vehicle response.

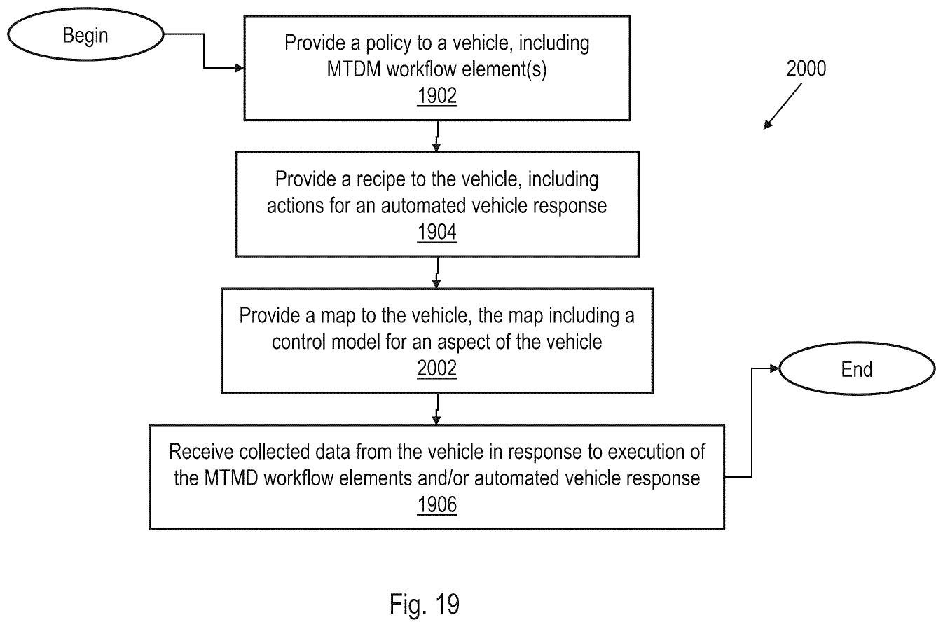

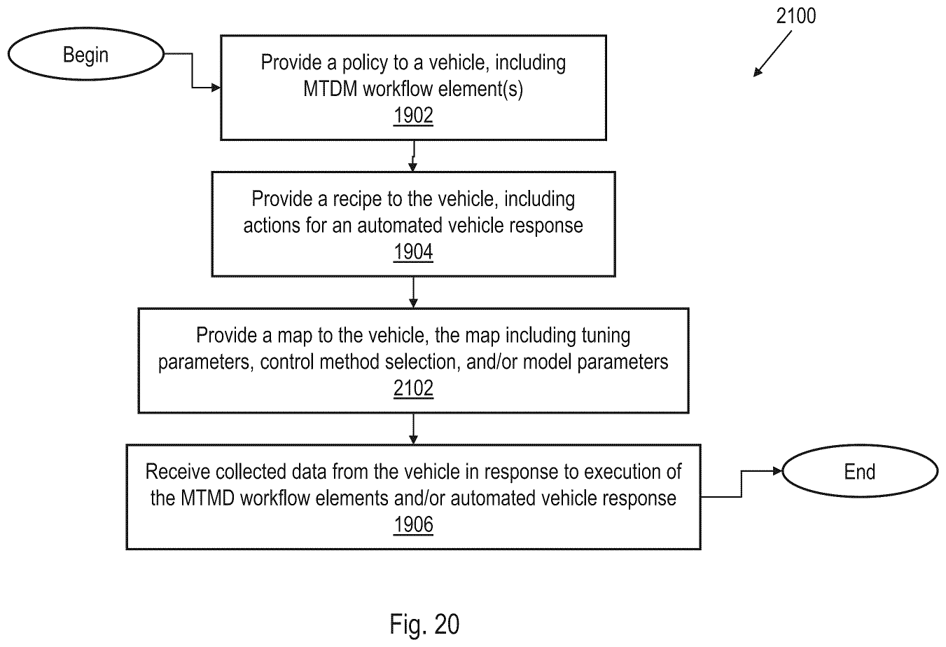

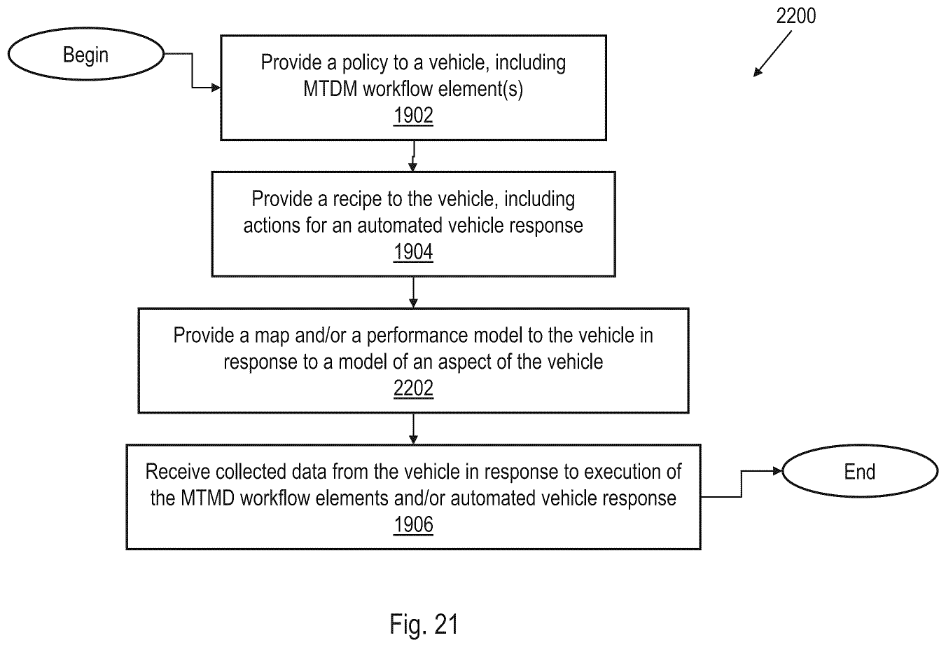

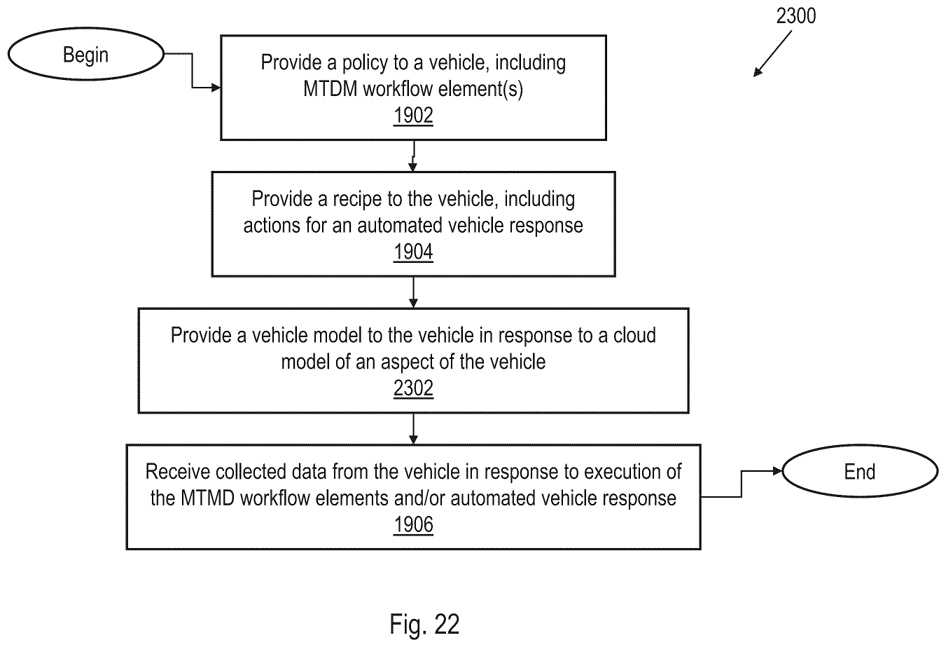

Referencing FIG. 19, an example procedure 2000 for a rollout operation is schematically depicted. The example procedure 2000, in addition to procedure 1900, includes an operation 2002 to provide a map to the vehicle, the map including a control model for an aspect of the vehicle. Referencing FIG. 20, an example procedure 2100 for a rollout operation is schematically depicted. The example procedure 2100, in addition to procedure 1900, includes an operation 2102 to provide a map to the vehicle, the map including tuning parameters, control method selection, and/or model parameters. Referencing FIG. 21, an example procedure 2200 for a rollout operation is schematically depicted. The example procedure 2200, in addition to procedure 1900, includes an operation 2202 to provide a map and/or a performance model to the vehicle in response to a model of an aspect of the vehicle. Referencing FIG. 22, an example procedure 2300 for a rollout operation is schematically depicted. The example procedure 2300, in addition to procedure 1900, includes an operation 2302 to provide a vehicle model to the vehicle in response to a cloud model of an aspect of the vehicle.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

While the disclosure has been disclosed in connection with certain embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

What is claimed is:

1. A system for performing an MTDM workflow, comprising:
a vehicle data platform configured to provide a policy to a vehicle, the policy comprising an MTDM workflow element;
a vehicle automation platform configured to provide a recipe to the vehicle, the recipe comprising actions for an automated vehicle response; and
wherein the vehicle data platform is further configured to receive collected data from the vehicle in response to an execution of at least one of the MTDM workflow element or the automated vehicle response by a controller of the vehicle.

2. The system of claim 1, wherein the MTDM workflow element and the recipe together embody at least a portion of an MTDM workflow comprising at least one of:
a monitoring operation, a maintenance operation, and further monitoring operation;
a monitoring operation, a testing operation, a further monitoring operation, and a further testing operation;
a monitoring operation, a diagnostic operation, a further monitoring operation, and a testing operation; or
a monitoring operation, a diagnostic operation, a further monitoring operation, and a further diagnostic operation.

3. The system of claim 1, wherein the vehicle automation platform is further configured to provide a map to the vehicle, the map comprising a control model for at least one aspect of the vehicle.

4. The system of claim 3, wherein the at least one aspect comprises at least one of:
a motor of the vehicle;
a component of the vehicle;
a powertrain of the vehicle; or
an end point of the vehicle.

5. The system of claim 3, wherein the at least one aspect comprises a flow of the vehicle.

6. The system of claim 3, wherein the at least one aspect comprises an application of the vehicle.

7. The system of claim 1, wherein the vehicle automation platform is further configured to provide a map to the vehicle, the map comprising at least one of:
tuning parameters for a control algorithm of the vehicle;
a control method selection for a control algorithm of the vehicle; or
model parameters for a least one of: a virtual sensor of the vehicle, a feedforward component of a control algorithm of the vehicle, or a response model for an aspect of the vehicle.

8. The system of claim 1, further comprising a model of an aspect of the vehicle, wherein the vehicle automation platform is further configured to provide at least one of the recipe or a performance map to the vehicle in response to the model of the aspect of the vehicle.

9. The system of claim 1, further comprising a cloud model of an aspect of the vehicle, wherein the vehicle automation platform is further configured to provide a vehicle model of the aspect of the vehicle to the vehicle in response to the cloud model of the aspect of the vehicle.

10. The system of claim 9, wherein the vehicle model comprises a functional equivalent of the cloud model.

11. The system of claim 9, wherein the vehicle model comprises a reduced version of the cloud model.

12. The system of claim 9, wherein the cloud model comprises an artificial intelligence model implemented by a data analytics component.

13. A method for performing an MTDM workflow, comprising:
providing a policy to a vehicle, the policy comprising an MTDM workflow element;
providing a recipe to the vehicle, the recipe comprising actions for an automated vehicle response;
receiving collected data from the vehicle in response to an execution of at least one of the MTDM workflow element or the automated vehicle response by a controller of the vehicle.

14. The method of claim 13, wherein the MTDM workflow element and the recipe together embody at least a portion of an MTDM workflow comprising at least one of:
a monitoring operation, a maintenance operation, and further monitoring operation;
a monitoring operation, a testing operation, a further monitoring operation, and a further testing operation;
a monitoring operation, a diagnostic operation, a further monitoring operation, and a testing operation; or
a monitoring operation, a diagnostic operation, a further monitoring operation, and a further diagnostic operation.

15. The method of claim 13 further comprising:
providing a map to the vehicle, the map comprising a control model for at least one aspect of the vehicle.

16. The method of claim 15, wherein the at least one aspect comprises at least one of:
a motor of the vehicle;
a component of the vehicle;
a powertrain of the vehicle; or
an end point of the vehicle.

17. The method of claim 15, wherein the at least one aspect comprises a flow of the vehicle.

18. The method of claim 15, wherein the at least one aspect comprises an application of the vehicle.

19. The method of claim 13 further comprising:
providing a map to the vehicle, the map comprising at least one of:
tuning parameters for a control algorithm of the vehicle;
a control method selection for a control algorithm of the vehicle; or
model parameters for a least one of: a virtual sensor of the vehicle, a feedforward component of a control algorithm of the vehicle, or a response model for an aspect of the vehicle.

20. The method of claim 13 further comprising providing at least one of the recipe or a performance map to the vehicle in response to a model for an aspect of the vehicle.

21. The method of claim 13 further comprising providing a vehicle model for an aspect of the vehicle to the vehicle in response to a cloud model for an aspect of the vehicle.

22. The method of claim 21, wherein the vehicle model comprises a functional equivalent of the cloud model.

23. The method of claim 21, wherein the vehicle model comprises a reduced version of the cloud model.

24. The method of claim 21, wherein the cloud model comprises an artificial intelligence model implemented by a data analytics component.
